(19) United States
(12) Patent Application Publication
(10) Pub. No.: US 2011/0058546 A1
(43) Pub. Date: Mar. 10, 2011

(54) Transmission Apparatus, Transmission Method and Non-Transitory Computer-Readable Recording Medium Thereof

(75) Inventors: Masamichi KASA, Fukuoka (JP); Shinichi Fujiyoshi, Fukuoka (JP)

(73) Assignee: FUJITSU LIMITED, Kawasaki-shi (JP)

(21) Appl. No.: 12/845,863

(22) Filed: Jul. 29, 2010

(30) Foreign Application Priority Data
Jul. 31, 2009 (JP) 2009-179199

(51) Int. Cl. H04L 12/56

(52) U.S. Cl. 370/389

(57) ABSTRACT

A transmission apparatus for receiving frames from one transmission path, storing the frames in plural buffers, and transmitting the frames to another transmission path in which an estimated discard time determination part configured to determine an estimated discard time of the frames stored in the plural buffers, a transmission order determination part configured to determine a transmission order of the frames, an estimated transmission time calculation part configured to calculate an estimated transmission time of each of the frames based on the transmission order, and a discard control part configured to discard a target frame from the frames stored in the plural buffers based on the estimated transmission time and the estimated discard time in a case where the estimated discard time of the target frame is the same as or earlier than the estimated transmission time of the target frame, are provided.

### CROSS-REFERENCE TO RELATED APPLICATIONS

This application is based upon and claims the benefit of priority of Japanese Patent Application No. 2009-179199 filed on Jul. 31, 2009, the entire contents of which are incorporated herein by reference.

### FIELD

The embodiments discussed herein are related to an apparatus, a method, and a non-transitory computer-readable recording medium for storing a frame received from a transmission path into a buffer of plural buffers, reading the frame from the buffer, and transmitting the frame to another transmission path.

### BACKGROUND

For services provided by transmitting data (e.g., audio data, visual data) at real time, there is a strong demand for shortening the delay time (delay amount) of frames to be transmitted by a transmission apparatus. Thus, a permissible delay time (amount of time permitted for frames to be retained in the transmission apparatus) is set in the transmission apparatus. Accordingly, in a case where the time between receiving a frame to transmitting the frame exceeds the permissible delay time, the frame loses validity. As a result, the frame retained in the transmission apparatus is discarded. This is hereinafter referred to as “delay discard”.

For example, a frame transfer apparatus according to a related art example includes time measuring parts provided in correspondence with each of plural FIFO memories. The time measuring part measures time elapsed after storing a new frame at the top of a corresponding FIFO memory. The frame transfer apparatus according to the related art example also includes a frame discarding part that discards a frame located at the head (top) of a FIFO memory in a case where the time measured by the time measuring part corresponding to the FIFO memory surpasses a predetermined permissible delay time (see, for example, Japanese Laid-Open Patent Publication No. 2008-235988).

With a transmission apparatus that transmits frames from plural users, the transmission apparatus may have buffers corresponding to each of the users for maintaining equality among the users. However, by providing buffers in correspondence with the users, the opportunity of transmission for each buffer is reduced in a case where there is an increase of users or an increase of data. Thus, a large amount of frames is stored in each buffer. As a result, newly received frames are discarded due to lack of available space in the buffer. This is referred to as an overflow.

The frame transfer apparatus disclosed in Japanese Laid-Open Patent Publication No. 2008-235988 measures time after frames are arranged, at the heads of classes formed of FIFO memories and is unable to discard the frames until a predetermined timeout time has elapsed. Therefore, in a congested state (overflow state) where frames accumulated in the classes have reached a maximum amount, a new frame to be stored in one of the classes is unable to be stored in the corresponding class and is discarded due to the overflow. Therefore, even in a case where a class contains frames to be discarded soon after a predetermined timeout time has elapsed, subsequent frames are discarded due to the overflow.

### SUMMARY

According to an aspect of the invention, there is provided a transmission apparatus for receiving frames from one transmission path, storing the frames in plural buffers, and transmitting the frames to another transmission path, the transmission apparatus including: an estimated discard time determination part configured to determine an estimated discard time of the frames stored in the plural buffers; a transmission order determination part configured to determine a transmission order of the frames; an estimated transmission time calculation part configured to calculate an estimated transmission time of each of the frames based on the transmission order; and a discard control part configured to discard a target frame from the frames stored in the plural buffers based on the estimated transmission time and the estimated discard time in a case where the estimated discard time of the target frame is the same as or earlier than the estimated transmission time of the target frame.

The object and advantages of the invention will be realized and attained by means of the elements and combinations particularly pointed out in the claims.

It is to be understood that both the foregoing generation description and the followed detailed description are exemplary and explanatory and are not restrictive of the invention, as claimed.

### BRIEF DESCRIPTION OF DRAWINGS

FIG. 1 is a schematic diagram illustrating a transmission apparatus according to an embodiment of the present invention;

FIGS. 2A and 2B are flowcharts illustrating of operations performed by the transmission apparatus of FIG. 1;

FIG. 3 is a flowchart illustrating a sequential estimation operation of the transmission apparatus of FIG. 1;

FIG. 4 is a flowchart of the sequential estimation operation continuing from FIG. 3;

FIG. 5 is a flowchart of the sequential estimation operation continuing from FIG. 4;

FIGS. 6A and 6B are describing a comparative example for comparing with the sequential estimation operation of the transmission apparatus of FIG. 1

FIGS. 7A and 7B are schematic diagrams for describing the sequential estimation operation of the transmission apparatus of FIG. 1;

FIG. 8 is a block diagram illustrating a transmission apparatus according to a second embodiment of the present invention;

FIG. 9 is a schematic diagram for describing an example before the storage state of storage buffers is changed in a sequential estimation correction operation of the transmission apparatus of FIG. 8;

FIG. 10 is a schematic diagram for describing a storage location where the results of the sequential estimation process of the FIG. 9 are changed;

FIGS. 11A-11B are schematic diagrams for describing a sequential estimation correction operation according to an embodiment of the present invention in a case where a new frame is stored in the first buffer of FIG. 9;

FIGS. 12A-12B are schematic diagrams for describing a sequential estimation correction operation according to an embodiment of the present invention in a case where a new frame is stored in the second buffer of FIG. 9;

FIGS. 13A-13B are schematic diagrams for describing a sequential estimation correction operation according to an embodiment of the present invention in a case where a new frame is stored in the third buffer of FIG. 9;

FIGS. 14A-14B are schematic diagrams for describing a sequential estimation correction operation according to an embodiment of the present invention in a case where a new frame is stored in the fourth buffer of FIG. 9; and

FIGS. 15A-15C are schematic diagrams for describing an operation performed, by a transmission apparatus according to a third embodiment of the present invention.

### DESCRIPTION OF EMBODIMENTS

Although the present invention is described below with embodiments of a transmission apparatus, the present invention may also be described in the form of other types of hardware, in the form of software (program), in the form of both hardware and software, or in the form of a method.

The program may be optically or magnetically recorded on a hard disk, a CD-ROM (Compact Disc Read-Only Memory), a DVD-ROM (Digital Versatile Disc Read-Only Memory), or any other non-transitory computer-readable recording medium.

### First Embodiment

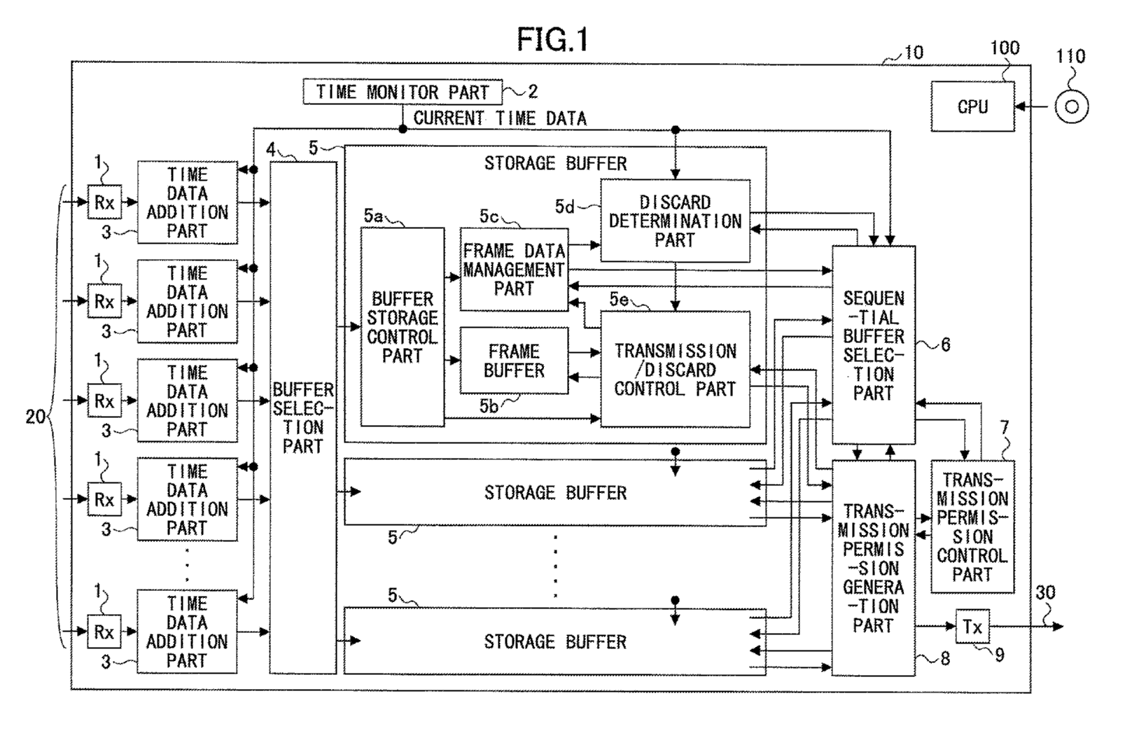

FIG. 1 is a schematic diagram illustrating a transmission apparatus 10 according to an embodiment of the present invention. The transmission apparatus 10 receives frames from a transmission path 20, stores the received frames in one of plural buffers, reads the frames from the buffer, and transmits the frames to another transmission path 30. The term “frame” may also be expressed with other units of data such as “packet” or “cell”. The transmission apparatus 10 may be, for example, an apparatus connected between an intranet and the Internet. However, the transmission apparatus 10 is not limited to such an apparatus.

The transmission apparatus 10 according to this embodiment includes reception ports 1, a time monitor part 2, time data addition parts 3, a buffer selection part 4, storage buffers 5, a sequential buffer selection part 6, a transmission permission control part 7, a transmission permission generation part 8, and a transmission port 9. The transmission apparatus 10 includes a CPU (Central Processing Unit) 100 for controlling the functions and processes performed by the below-described parts and elements included in the transmission apparatus 10. A program for performing a transmission method according to an embodiment of the present invention may be installed in the transmission apparatus 10 via a non-transitory computer-readable recording medium 110.

The reception port 1 has a function of receiving frames transmitted from other communication apparatuses and communication terminals via the transmission path 20. The transmission apparatus 10 may have one or more of the reception ports 1. The time monitor part 2 manages data of time (time data) shared (commonly used) by other components and elements of the transmission apparatus 10.

The time data addition part 3 adds data of the current time (current time data) input from the time monitor part 2 to the frame received from the reception port 1. The data of the current time are added as “reception time data” to the frame. The addition of the reception time data may be performed by, for example, storing the reception time data in a storage space of the frame or transmitting the reception time data in parallel with the frame.

The buffer selection part 4 selects one of plural storage buffers 5 to which the frame with reception time data added is assigned. The storage buffers 5 may be selected based on conditions such as the transmission origin (communication apparatus such as another transmission apparatus) of the frame, the number of the reception port 1 receiving the frame, the priority of the frame, or a combination of these conditions. The frame is then output to the storage buffer 5 selected and assigned by the buffer selection part 4. The frame may be set with a predetermined condition and output to one of the plural storage buffers 5 that matches the predetermined condition.

In this embodiment, plural storage buffers 5 are arranged in the transmission apparatus 10. Each storage buffer 5 includes elements such as a buffer storage control part 5a, a frame buffer 5b, a frame data management part 5c, a discard determination part 5d, and a transmission/discard control part 5e. The elements 5a-5e of the storage buffers 5 perform various processes on each other. In the embodiment illustrated in FIG. 1, the storage buffers 5 are provided in correspondence with the users and are set with equal priority. Although not illustrated in FIG. 1, the transmission apparatus 10 includes another storage buffer having a priority higher or lower than that of the storage buffers 5.

The buffer storage control part 5a stores the frame input from the buffer selection part 4 in the frame buffer 5b and reports the storing of the frame to the frame data management part 5c.

The frame buffer 5b includes a functional configuration such as Queue or FIFO (First-In-First-Out). The frame buffer 5b may use a memory.

The frame data management part 5c registers data of each frame (frame management data) stored in the frame buffer 5b. The frame management data include data pertaining to, for example, the reception time data of a frame, the storage order of a frame, the data length of a frame, or the frame number of a frame. In a case where the frame stored in the frame buffer 5b is a frame having a fixed length, the frame management data include at least data pertaining to the reception time and the storage order of the frame. In a case where the frame stored in the frame buffer 5b is a frame having a variable length, the frame management data include at least data pertaining to the reception time, the storage order, and the frame length of the frame. Whenever the buffer storage control part 5a stores a frame in the frame buffer 5b or whenever the transmission/discard control part 5e transmits or discards a frame(s) from the frame buffer 5b, the frame data management part 5c updates the frame management data. In a case where a frame(s) exists in the frame buffer 5b, the frame data management part 5c sends requests for transmission of the frame(s) in the frame buffer 5b to the sequential buffer selection part 6.

Further, in a case where a frame corresponding to a storage order designated by the sequential buffer selection part 6 exists in the frame buffer 5b, the frame data management part 5c reports the reception time data of the frame to the discard determination part 5d.

The sequential buffer selection part 6 selects one of the storage buffers 5 corresponding to the transmission request by the frame data management part 5c and reports the selection to the transmission permission generation part 8. The sequential buffer selection part 6 performs the selection based on a predetermined rule. The predetermined rule may be, for example, round robin or SP (Strict Priority).

The sequential buffer selection part 6 calculates the estimated time in which each frame in the storage buffer 5 is to be transmitted (estimated transmission time) whenever a frame is stored in the storage buffer 5. The sequential buffer selection part 6 calculates the estimated transmission time based on the reception time (current time) of the frame and the interval between transmissions of consecutive frames (hereinafter also referred to as “transmission interval”). The sequential buffer selection part 6 also calculates the estimated transmission time whenever a frame is to be read out from the storage buffer 5. The sequential buffer selection part 6 calculates the estimated transmission time based on the reception time (current time) of the frame and the transmission interval.

That is, the sequential buffer selection part 6 selects one of the plural storage buffers 5 based on the predetermined rule. Then, the sequential buffer selection part 6 designates a storage order of the frames of the selected buffer 5 starting from the earliest frame (frame having the oldest reception time) and outputs data pertaining to the storage order (hereinafter also referred to as “storage order data”) to the frame data management part 5c. Then, the sequential buffer selection part 6 calculates the estimated transmission time of the frames corresponding to the designated storage order and outputs data pertaining to the calculated estimated transmission times (hereinafter also referred to as “estimated transmission time data”) to the discard determination part 5d. Accordingly, the sequential buffer selection part 6 serves as a unit that determines the order of transmitting the frames in the storage buffers 5 (transmission order determination unit) and a unit that calculates the estimated transmission time of each frame stored in the storage buffers 5 based on the determined transmission order (estimated transmission time calculation unit).

In a case where a request for discarding a frame is output to the discard determination part 5d, the sequential buffer selection part 6 designates a frame having a storage order number that is next in the storage order after the frame requested to be discarded and outputs the storage order data of the designated frame to the frame data management part 5c. In addition, the sequential buffer selection part 6 outputs the estimated transmission time data corresponding to the frame requested to be discarded as the estimated transmission time data corresponding to the designated frame (i.e. the designated frame having a storage order number that is next after the storage order number of the frame requested to be discarded) to the discard determination part 5d. In a case where a discard request is not output from the discard determination part 5d, the sequential buffer selection part 6 selects a storage buffer 5 which is next after the storage buffer 5 storing a frame subjected to a discard determination process (i.e. process of determining whether to discard a frame), designates a frame stored in the selected next storage buffer 5, and outputs storage order data of the designated frame to the frame data management part 5c. In a case where there is no frame corresponding to the selected storage order number, the sequential buffer selection part 6 selects a storage buffer 5 whose number is next in the storage order after the selected storage buffer 5.

The discard determination part 5d registers data of permissible delay time (hereinafter also referred to as “permissible delay time data”) and calculates the estimated time for discarding a frame (estimated discard time) based on the permissible delay time data and the reception time data received from the frame data management part 5c. That is, the discard determination part 5d calculates the estimated discard time by adding the reception time to the permissible delay time. Further, the discard determination part 5d determines whether the frame is to be discarded (discard determination process) based on the estimated discard time data and the estimated transmission time data of the frame. In a case where the discard determination part 5d determines that the frame is to be discarded, the discard determination part 5d outputs a discard request corresponding to the frame subjected to the discard determination process to the transmission/discard control part 5e. That is, in this embodiment, the discard determination part 5d compares the estimated discard time of a frame (calculated by the discard determination part 5d) and the estimated transmission time of the frame (input from the sequential buffer selection part 6) and outputs a discard request (also referred to as “discard request notice”) corresponding to the frame to the transmission/discard control part 5e in a case where the estimated discard time is the same or earlier than the estimated transmission time. Further, in a case where the discard determination part 5d outputs the discard request to the transmission/discard control part 5e, the discard determination part 5d reports that the frame is to be discarded by the transmission/discard control part 5e to the sequential buffer selection part 6. In a case where the discard request is not output to the transmission/discard control part 5e, the discard determination part 5d reports that the frame is not to be discarded by the transmission/discard control part 5e to the sequential buffer selection part 6.

In this embodiment, one of the discard determination parts 5d is provided inside each of the plural storage buffers 5. In an alternative example, a single discard determination part 5d may be provided outside of the storage buffer 5. In this alternative example, discard determination processes performed with respect to some or all of the storage buffers 5 can be concentrated in the single discard determination part 5d.

The permissible delay time may be a fixed value that is set beforehand when designing the transmission apparatus 10 or an arbitrary value set by an administrator of the transmission apparatus 10. Further, the permissible delay time maybe commonly set for all storage buffers 5 or set individually for the storage buffers 5.

In this embodiment, the permissible delay time data are registered in the discard determination part 5d. However, in an alternative example, the permissible delay time data may be registered in the time monitor part 2 or the frame data management part 5c, so that the time monitor part 2 or the frame management part 5c can calculate the estimated discard time by adding the permissible delay time to the reception time. In this alternative example, in a case where a frame corresponding to a storage order designated by the sequential buffer selection part 6 exists in the frame buffer 5c, the time monitor part 2 or the frame data management part 5c outputs (reports) the estimated discard time data of the frame to the discard determination part 5d.

Hence, as described above, the discard determination part 5d, the time monitor part 2, or the frame data management part 5c serves as a unit that determines the estimated discard time of a frame stored in the storage buffer 5 (estimated discard time determination unit).

The transmission permission control part 7 manages data used for identifying the estimated transmission time (including, for example, transmission interval) of frames (hereinafter also referred to as “estimated transmission time identification data). The transmission permission control part 7 reports the estimated transmission time identification data to the sequential buffer selection part 6 based on a request from the sequential buffer selection part 6. Further, the transmission permission control part 7 determines the timing in which the next frame can be transmitted. The determination of the transmission of the next frame is based on the timing reported from the transmission permission generation part 8. The timing reported from the transmission permission generation part 8 may be the timing for starting transmission of frames from the transmission port 9 or the timing for completing (terminating) transmission of frames from the transmission port 9. Based on the determined timing, the transmission permission control part 7 sends (issues) a request for permission to transmit (transmission permission request) to the transmission permission generation part 8. It is to be noted that the interval for sending (issuing) the transmission permission request is also the interval for transmitting frames.

In a case where the transmission permission control part 7 is issuing a transmission permission request with respect to the transmission port 9, the transmission permission generation part 8 sends (issues) a report indicating that transmission of the frame is permitted (transmission permission report) to the transmission/discard control part 5e.

In a case where the transmission permission report is issued by the transmission permission generation part 8, the transmission/discard control part 5e reads a frame(s) stored in the frame buffer 5b starting from the one having the earliest storage order and outputs the read frame(s) to the transmission port 9 via the transmission permission generation part 8. The transmission/discard control part 5e reports the frame has been output to the transmission permission generation part 8 (outputting the frame from the transmission port 9) to the frame data management part 5c.

In a case where a request for discarding a frame (discard request) is input from the discard determination part 5d to the transmission/discard control part 5e, the transmission/discard control part 5e discards the frame corresponding to the discard request from the frame buffer 5b and reports the discarding of the frame to the frame data management part 5c. That is, in a case where the estimated discard time of the frame is the same or earlier than the estimated transmission time of the frame, the transmission/discard control part 5e discards the frame before the next frame is stored in the frame buffer 5b or before the next frame is read from the frame buffer 5b.

The transmission port 9 includes a function of transmitting frames to other communication apparatuses and terminals via the transmission path 30. Although one transmission port 9 is illustrated in the embodiment of FIG. 1, the transmission apparatus 10 may have an arrangement of plural transmission ports 9.

Next, an operation including various processes performed by the transmission apparatus 10 according to an embodiment of the present invention is described.

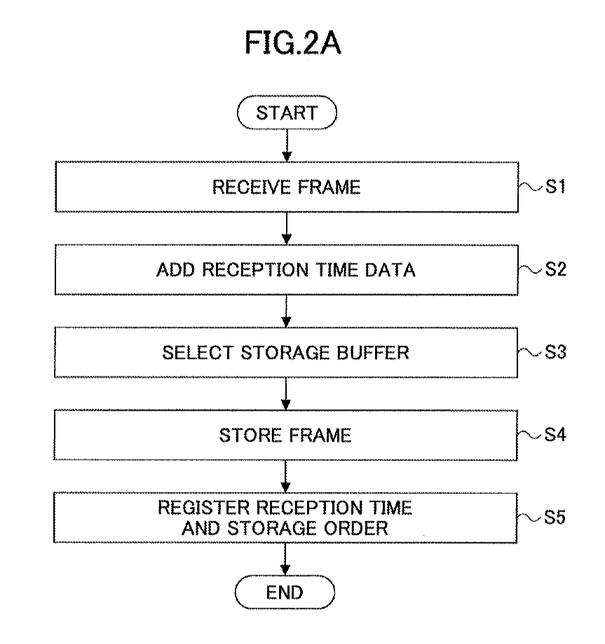

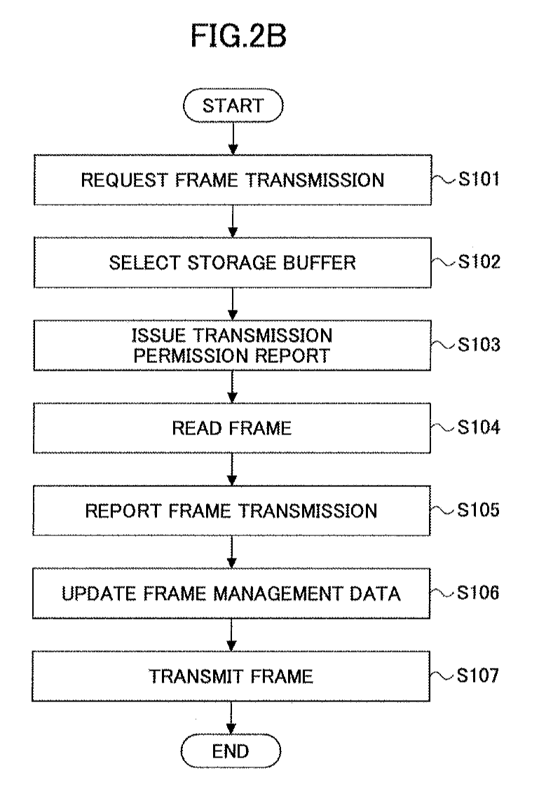

First, processes performed between a procedure of receiving a frame from the transmission path 20 and a procedure of storing the frame in the storage buffer 5 are described with reference to FIG. 2A.

First, when the reception port 1 receives a frame from the transmission path 20, the reception port 1 outputs the frame to the time data addition part 3 (Step S1).

Then, the time data addition part 3 adds the current time data input from the time monitor part 2 to the frame (Step S2). The current time data added to the frame serves as the reception time data of the frame.

The buffer selection part 4 selects a storage buffer 5 from the plural storage buffers 5 based on a predetermined condition (e.g., the number of the reception port 1 that received the frame) and outputs the frame to the buffer storage control part 5a of the selected storage buffer 5 (Step S3).

Then, the buffer storage control part 5a stores the frame in the frame buffer 5b and outputs data reporting the storage of the frame to the frame data management part 5c (Step S4). The data sent to the frame data management part 5c include the reception time data and the storage order data of the frame. Further, in a case where the frame is a variable length frame, the data sent to the frame data management part 5c may also include the amount of data of the frame (frame length).

The frame data management part 5c registers (writes) the reception time data and the storage order data received from the buffer storage control part 5a. In a case where the frame is a variable length frame, the frame management part 5c also registers the frame length (Step S5).

Next, processes performed between a procedure of reading a frame from the storage buffer 5 and a procedure of transmitting the frame to the transmission path 30 are described with reference to FIG. 2B.

In a case where one of the storage buffers 5 has a frame existing in its own frame buffer 5b, the frame data management part 5c of the storage buffer 5 having the frame existing therein sends a request for transmission of the frame to the sequential buffer selection part 6 (Step S101).

The sequential buffer selection part 6 selects one of the storage buffers 5 having its frame data management part 5c requesting transmission of a frame and reports data indicating the selection to the transmission permission generation part 8 (Step S102). The sequential buffer selection part 6 selects the storage buffer 5 based on a predetermined rule (e.g., round-robin).

In a case where the transmission permission control part 7 is issuing a transmission permission request to the transmission port 9, the transmission permission generation part 8 outputs a transmission permission report to the transmission/discard control part 5e (Step S103).

It is to be noted that the transmission permission control part 7 issues the transmission permission requests in correspondence with the timing in which frames can be transmitted.

The transmission/discard control part 5e reads a frame from the frames stored in the frame buffer 5b in an order starting from the head (front) frame having the earliest storage number (Step 104).

Then, the transmission/discard control part 5e outputs the frame read from the frame buffer 5b and reports to the frame data management part 5C that the frame has been transmitted to the transmission permission generation part 8 (frame transmission) (Step S105).

The frame data management part 5c updates the frame management data (Step S106). That is, the frame data management part 5c deletes the reception time data of the read frame and corrects the storage order data of the frames by moving up the storage order.

The transmission permission generation part 8 outputs the frame from the transmission/discard control part 5e to the transmission port 9. Then, the transmission port 9 transmits the frame from the transmission permission generation part 8 to the transmission path 30 (Step S107).

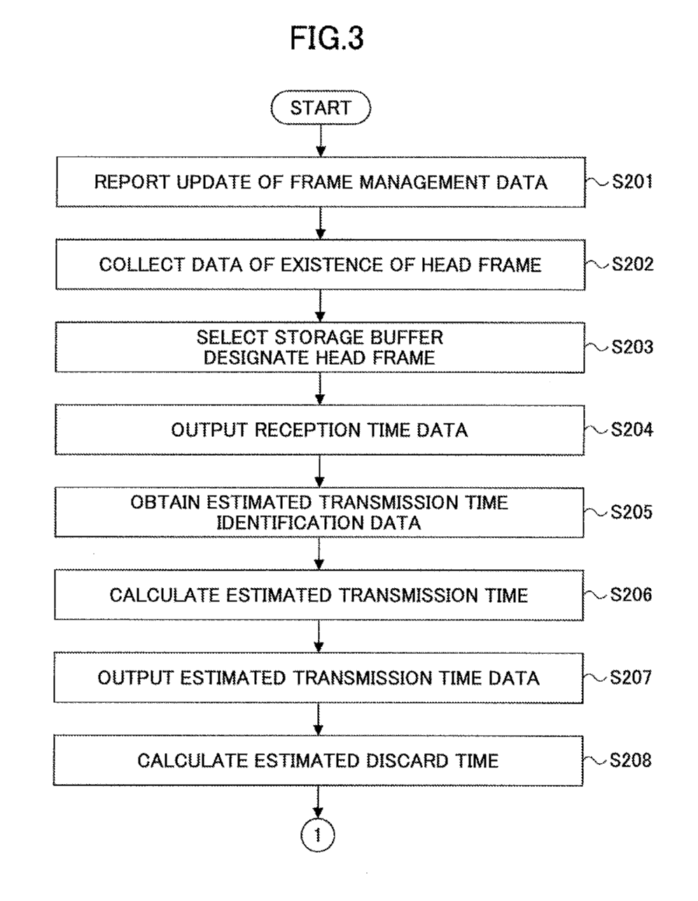

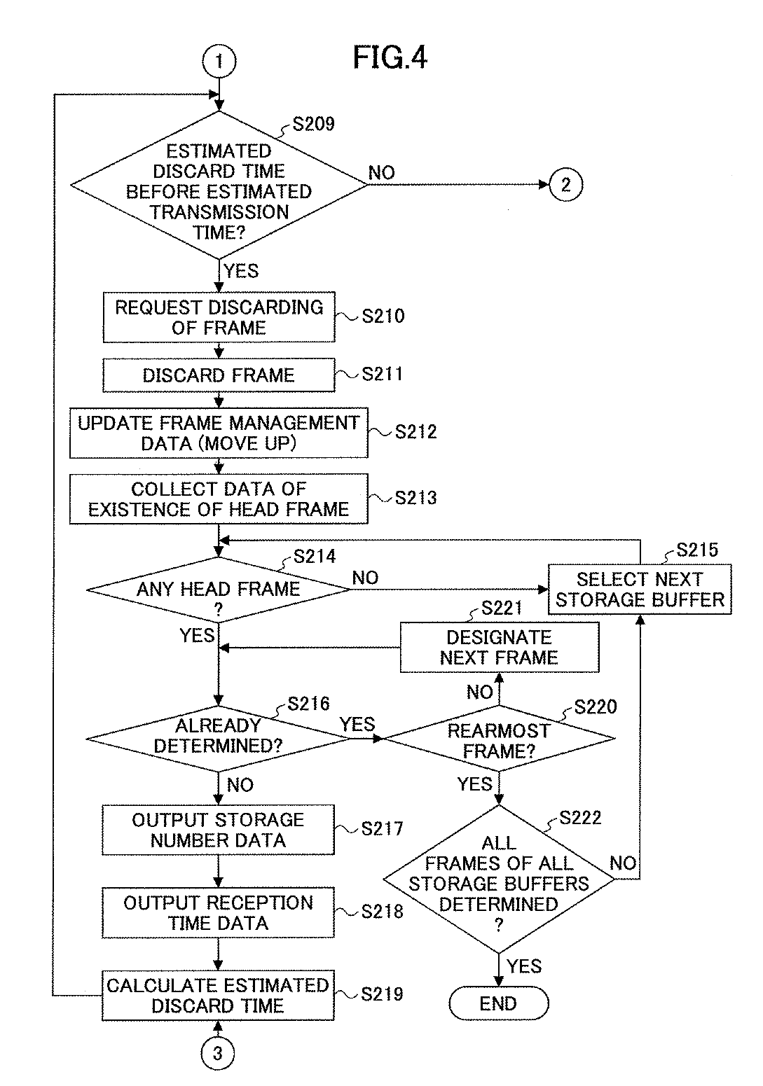

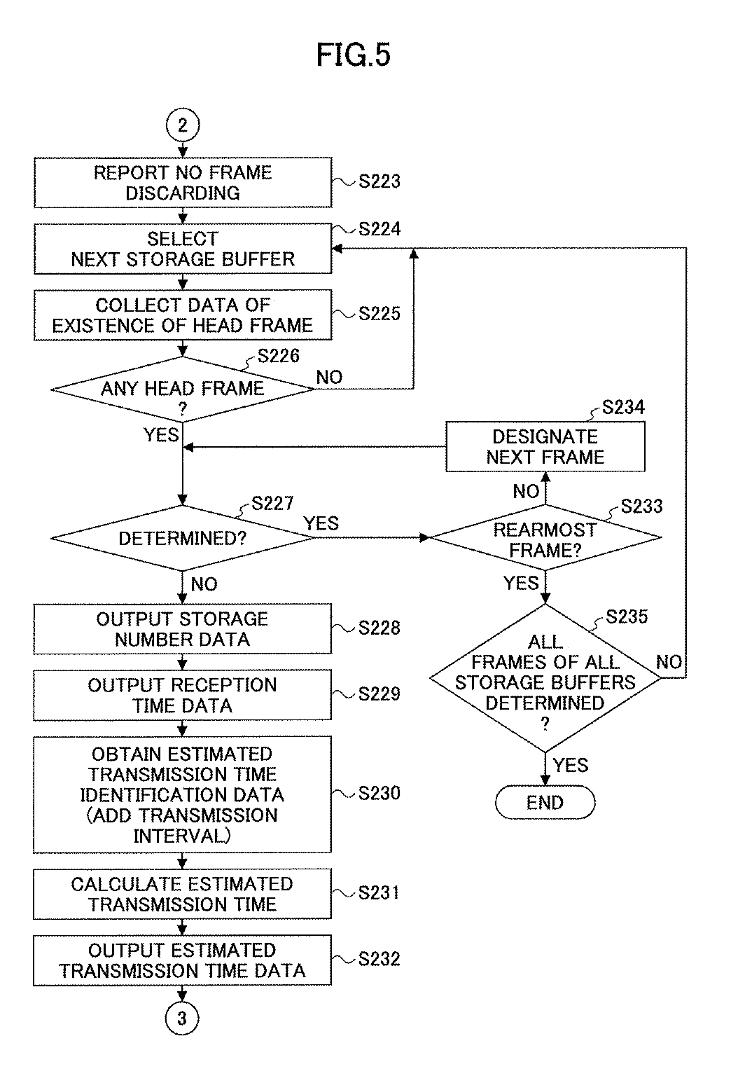

Next, an operation for estimating the transmission order and the transmission time of each frame stored in the storage buffers 5 and estimating a frame to be discarded after the elapsing of a permissible delay time (hereinafter also referred to as “sequential estimation operation”) is described with reference to FIGS. 3-5.

The frame data management part 5c in each storage buffer 5 reports to the sequential buffer selection part 6 that frame management data have been updated due to a frame being stored in the corresponding frame buffer 5b or a frame being read out from the corresponding frame buffer 5b (Step S201).

The sequential buffer selection part 6 collects data indicating the existence of a frame(s) at the head (front) of the frame buffer 5b from the frame data management part 5c of the corresponding storage buffer 5. That is, the sequential buffer selection part 6 obtains data indicating whether there are any frames at the head (front) of the frame buffer 5b from the frame data management part 5c of each storage buffer 5 (Step S202). The data collected (obtained) from the frame data management part 5c may be expressed by, for example, storage numbers or the number of frames in the frame buffer 5b.

Then, in a case where a frame exists at the head (front) of the frame buffer 5b of one or more storage buffers 5, the sequential buffer selection part 6 selects a storage buffer 5 having the frame based on a predetermined rule (e.g., round-robin), designates the storage number of the frame, and outputs data of the designated storage number (storage number data) to the frame data management part 5c (Step S203).

The frame data management part 5c outputs reception time data of the frame corresponding to the designated storage number data to the discard determination part 5d (Step S204).

The sequential buffer selection part 6 requests estimated transmission time identification data to the transmission permission control part 7 and obtains the estimated transmission time identification data (Step S205).

Then, the sequential buffer selection part 6 calculates the estimated transmission time by adding the current time input from the time monitor part 2 to the transmission interval obtained from the estimated transmission time identification data (Step S206). In a case where this process is initiated by a frame being stored in the selected frame buffer 5b, the current time in Step S206 corresponds to the transmission time of the frame. In a case where this process is initiated by a frame being read from the selected frame buffer 5b, the current time in Step S206 corresponds to the reception time of the frame when the frame reception timing and the frame transmission timing of the transmission apparatus 10 are synchronizing.

The sequential buffer selection part 6 outputs the calculated estimated transmission time to the discard determination part 5d of the storage buffer 5 selected by the sequential buffer selection part 6. The estimated transmission time is the estimated transmission time data of the frame stored at the head of the frame buffer 5b of the selected storage buffer 5 (Step S207).

The discard determination part 5d calculates the estimated discard time of the frame based on the reception time data of the frame input from the frame data management part 5c. That is, the discard determination part 5d calculates the estimated discard time of the frame by adding the permissible delay time to the reception time of the frame (Step S208).

The discard determination part 5d determines whether the estimated discard time is the same as or earlier than the estimated transmission time by comparing the estimated discard time of the frame and the estimated transmission time of the frame input from the sequential buffer selection part 6 (Step S209).

In Step S209, in a case where the discard determination part 5d determines that the estimated discard time of the frame is the same as or earlier than the estimated transmission time, the discard determination part 5d outputs a request for discarding the frame (discard request) to the transmission/discard control part 5e. Further, the discard determination part 5d reports the discarding of the frame to the sequential buffer selection part 6 (Step S210).

The transmission/discard control part 5e discards the frame from the frame buffer 5b according to the discard request from the discard determination part 5d and reports the discarding of the frame to the frame data management part 5c (Step S211).

The frame data management part 5c updates the frame management data by deleting the reception time data of the discarded frame and correcting (in this case, moving up) the data of the storage order of the remaining frames (Step S212).

Then, when the sequential buffer selection part 6 receives the report of the discarding of the frame from the discard determination part 5d, the sequential buffer selection part 6 collects data indicating the existence of a frame at the head (front) of the frame buffer 5b of the currently selected storage buffer 5 (Step S213).

Then, the sequential buffer selection part 6 determines whether there is any frame stored at the head (front) of the frame buffer 5b of the currently selected storage buffer 5 (Step S214).

In a case where the sequential buffer selection part 6 determines that no frame is stored at the head of the frame buffer 5b in Step S214 (No in Step S214), the sequential buffer selection part 6 selects a storage buffer 5 permitted to have a frame read therefrom based on a predetermined rule. Further, the sequential buffer selection part 6 collects data indicating the existence of a frame at the head of the frame buffer 5b of the selected storage buffer 5 (Step S215). Then, the operation returns to Step S214.

In a case where the sequential buffer selection part 6 determines that a frame is stored at the head of the frame buffer 5b in Step S214 (Yes in Step S214), the sequential buffer selection part 6 determines whether the discard determination process has already been performed on the frame stored in the head of the frame buffer 5b (Step S216).

In a case where the sequential buffer selection part 6 determines that the discard determination process has not yet been performed for the frame (No in Step S216), the sequential buffer selection part 6 outputs the storage number data of the frame to the frame data management part 5c (Step S217).

The frame data management part 5c outputs reception time data of the frame corresponding to the storage number data to the discard determination part 5d (Step S218).

The discard determination part 5d calculates the estimated discard time of the frame based on the reception time data of the frame input from the frame data management part 5c. That is, the discard determination part 5d calculates the estimated discard time of the frame by adding the permissible delay time to the reception time of the frame (Step S219). Then, the operation returns to Step S209.

In a case where the sequential buffer selection part 6 determines that the discard determination process is performed for the frame (Yes in Step S216), the sequential buffer selection part 6 determines whether the frame is the rearmost frame (i.e. last frame of the storage order) in the frame buffer 5b (Step S220).

In a case where the sequential buffer selection part 6 determines that the frame is not the rear-most frame (Yes in Step S220), the sequential buffer selection part 6 determines whether the discard determination process has already been performed on all of the frames stored in the storage buffers 5 (Step S222).

In a case where the sequential buffer selection part 6 determines that the frame is not the rear-most frame (No in Step S220), the sequential buffer selection part 6 designates the next frame (Step S221) and the process returns to Step S216.

In a case where the sequential buffer selection part 6 determines that the discard determination process has not been performed on all of the frames (No in Step S222), the operation returns to Step S215.

In a case where the sequential buffer selection part 6 determines that the discard determination process has been performed on all of the frames (Yes in Step S222), the sequential estimation operation is terminated.

In a case where the discard determination part 5d determines that the estimated discard time is not the same as or earlier than the estimated transmission time (No in Step S209), the discard determination part 5d reports that the frame is not to be discarded to the sequential buffer selection part 6 (Step S223).

The sequential buffer selection part 6 selects the next storage buffer 5 permitting a frame to be read therefrom based on a predetermined rule (Step S224).

The sequential buffer selection part 6 determines whether there is any frame stored at the head (front) of the frame buffer 5b of the currently selected storage buffer 5 (Step S226).

In a case where the sequential buffer selection part 6 determines that there is no frame stored at the head (front) of the frame buffer 5b (No in Step S226), the operation returns to Step S224.

In a case where the sequential buffer selection part 6 determines that there is a frame stored at the head (front) of the frame buffer 5b (Yes in Step S226), the sequential buffer selection part 6 determines whether the discard determination process has already been performed on the frame stored at the head (front) of the frame buffer 5b (Step S227).

In a case where the sequential buffer selection part 6 determines that the discard determination process has not been performed on the frame stored at the head (front) of the frame buffer 56 (No in Step S227), the sequential buffer selection part 6 outputs storage number data of the frame to the frame data management part 5c (Step S228).

The frame data management part 5c outputs reception time data of the frame corresponding to the storage number data input from the sequential buffer selection part 6 (Step S229).

The sequential buffer selection part 6 requests the estimated transmission time identification data to be sent by the transmission permission control part 7 and obtains the estimated transmission time identification data (Step S230). In a case where the frame input to the transmission apparatus 10 is a fixed length frame and the transmission interval is constant, the sequential buffer selection part 6 may obtain new estimated transmission time identification data by adding the transmission interval to the currently maintained estimated transmission time identification data (transmission interval).

Then, the sequential buffer selection part 6 calculates the estimated transmission time by adding the transmission interval in the estimated transmission time identification data obtained in Step S230 to the current time obtained in Step S206 (Step S231).

The sequential buffer selection part 6 outputs the estimated transmission time data of the frame corresponding to the storage number data output in Step S228 to the discard determination part 5d of the selected storage buffer 5 (Step S232). Then, the operation proceeds to Step S219.

In a case where the sequential buffer selection part 6 determines that the discard determination process is performed on the frame stored at the head (front) of the frame buffer 5b (Yes in Step S227), the sequential buffer selection part 6 determines whether the frame is the rear-most frame (i.e. last frame of the storage order) in the frame buffer 5b (Step S233).

In a case where the sequential buffer selection part 6 determines that the frame is not the rear-most frame (No in Step S233), the sequential buffer selection part 6 designates a next frame (a frame having a storage order next after the frame) (Step S234). Then, the operation returns to Step S227.

In a case where the sequential buffer selection part 6 determines that the frame is the rear-most frame (Yes in Step S233), the sequential buffer selection part 6 determines whether the discard determination process has already been performed on all of the frames stored in the storage buffers 5 (Step S235).

In a case where the sequential buffer selection part 6 determines that the discard determination process has not been performed on all of the frames stored in the storage buffers 5 (No in Step S235), the operation returns to Step S224.

In a case where the sequential buffer selection part 6 determines that the discard determination process has been performed on all of the frames stored in the storage buffers 5 (Yes in Step S235), the sequential estimation operation is terminated.

Next, a specific example of the sequential estimation operation is described.

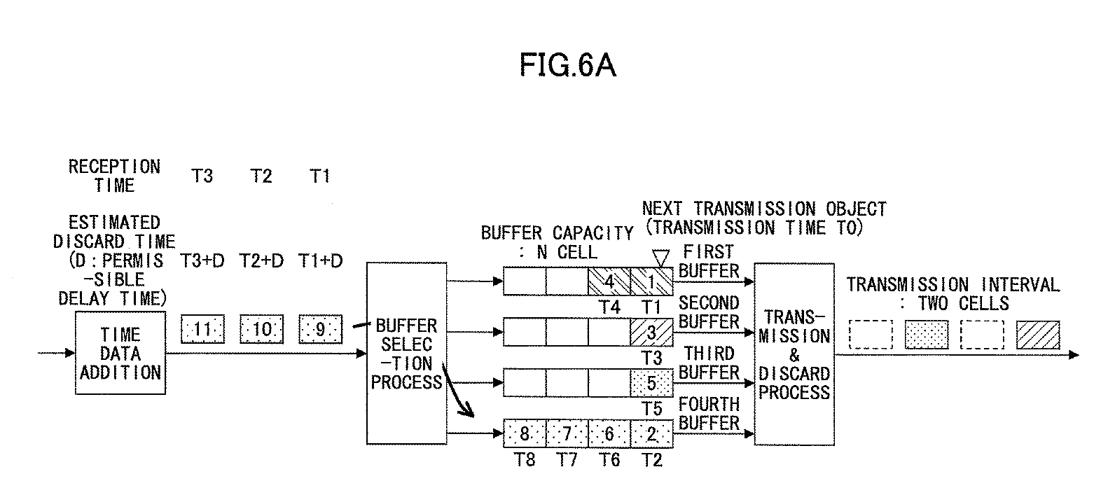

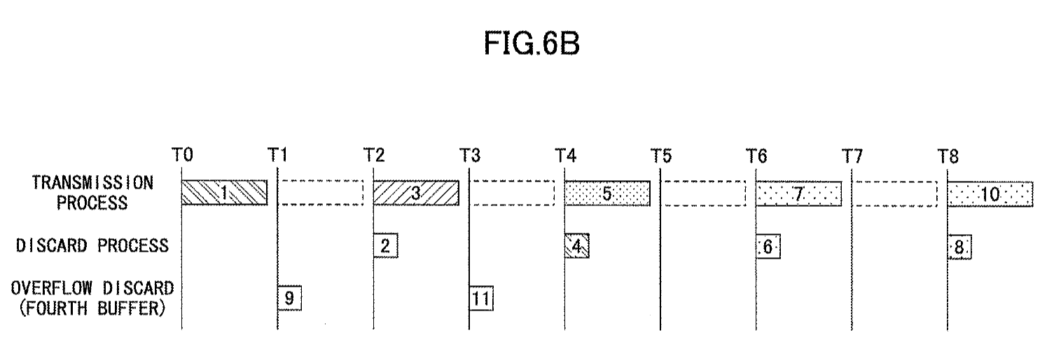

First, in describing the sequential estimation operation, a comparative example is described with reference to FIGS. 6A and 6B. With the comparative example, a frame is not discarded until the time in which the frame is retained time in the transmission apparatus 10 (retain time) surpasses the permissible delay time.

For the sake of simplifying the explanation, FIGS. 6A and 6B illustrates a case where the frames received by the transmission apparatus of the comparative example have fixed length (e.g., ATM (Asynchronous Transfer Mode), the sequential transmission frames (cells) are transmitted at a minimum transmission interval equivalent to that of a single frame, and a round-robin method is used as the rule for transmitting the frames.

Further, in FIGS. 6A and 6B, Tn (n=1, 2, . . . ) indicates time data. For example, “T0” represents the current time. Thereby, the units of the time required for transmitting a single frame are expressed by the time (T1, T2, T3, . . . ) elapsed from the current time (T0).

As illustrated in FIG. 6A, the transmission apparatus of the comparative example has four buffers (first buffer, second buffer, third buffer, fourth buffer). The number of frames that can be stored in each buffer (buffer capacity) is four. The frames are illustrated with different hatchings in correspondence with the buffers. For the sake of convenience, each frame is assigned a number for identifying that frame (identification number). In FIG. 6A, the time data Tn (n=1, 2, . . . ) illustrated below the frames of the first-fourth buffers represent the estimated discard time calculated by adding the permissible delay time to reception time.

The number of frames stored in the first-fourth buffers at the current time T0 is two, one, one, and four, respectively. The frames to be assigned to the fourth buffer (identification numbers 9, 10, and 11) are sequentially received at minimum intervals at times T1, T2, and T3.

First, in a case where the first buffer is selected based on the round-robin rule and the frame (identification number 1) stored at the head (front) of the first buffer is transmitted at the time T0, the transmission time of the next frame is T2 because the minimum transmission interval to reach the transmission port is one frame. Accordingly, the second buffer is selected based on the round-robin rule and the frame (identification number 3) stored at the head of the second buffer is transmitted at the time T2.

In the fourth buffer, although a frame having an identification number 9 is received at the time T1, the frame having the identification number 9 is discarded (overflow) because the fourth buffer already has four frames stored therein and has no available buffer capacity.

Further, because the frame (identification number 2) stored at the head of the fourth buffer has reached the estimated discard time at time T2, the frame having identification number 2 is discarded without being transmitted. Thereby, the fourth buffer has an available capacity equivalent to a single frame. Accordingly, the frame (identification number 10) received at timing T2 can be stored in the fourth buffer. Due to the discarding of the frame having identification number 2, the storage order of the frames (identification numbers 6, 7, and 8) moves up. Thus, the frame having the identification number 6 becomes the frame stored at the head of the fourth buffer.

Although a frame having an identification number 11 is received at the time T3, the frame having the identification number 11 is discarded because the number of frames stored in the fourth buffer is four and there is no available buffer capacity (overflow).

Further, because the estimated discard time of the frame having the identification number 6 stored at the head of the fourth buffer is time T6, the frame having the identification number 6 is discarded without being transmitted.

In FIG. 6B, the transmitted frames and corresponding transmission times are illustrated in the top row, the frames discarded due to reaching the estimated discard times and corresponding discard time are illustrated in the middle row, the frames discarded due to overflow and corresponding discard time are illustrated in the bottom row.

The newly received frames having identification numbers 9 and 11 are discarded because the frames having identification numbers 2 and 6 are not discarded until the estimated discard time is reached. Therefore, without performing the sequential estimation operation according to an embodiment of the present invention, the number of frames increases and adversely affects transmission efficiency. In addition, the re-transmitting of the discarded frames further increases the traffic handled by the transmission apparatus.

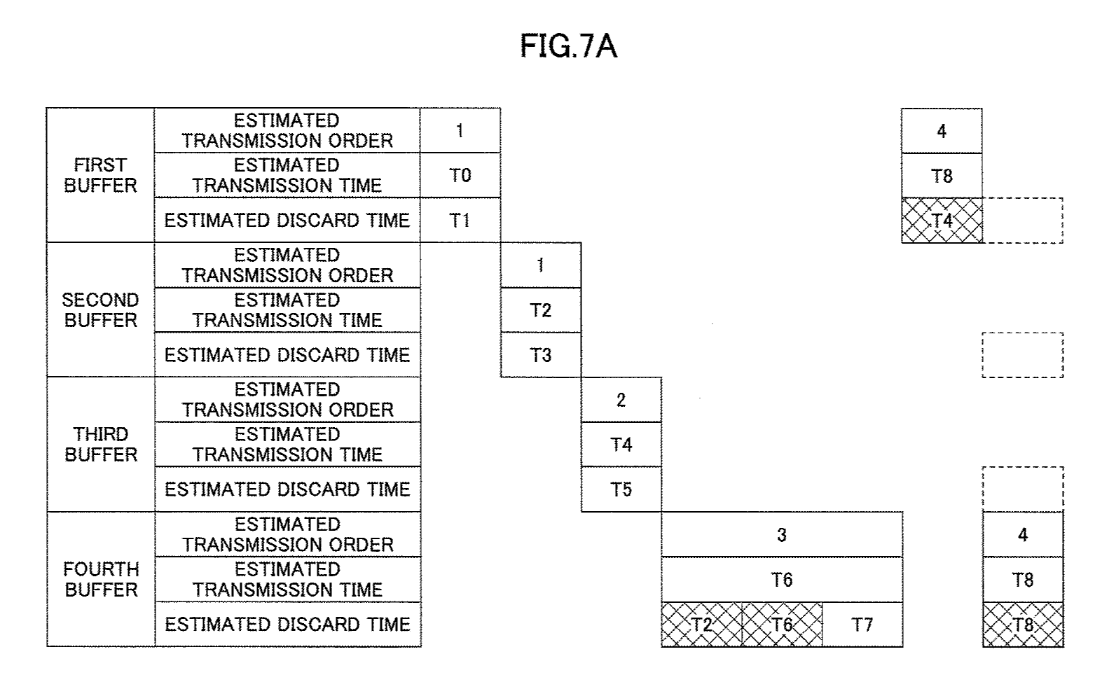

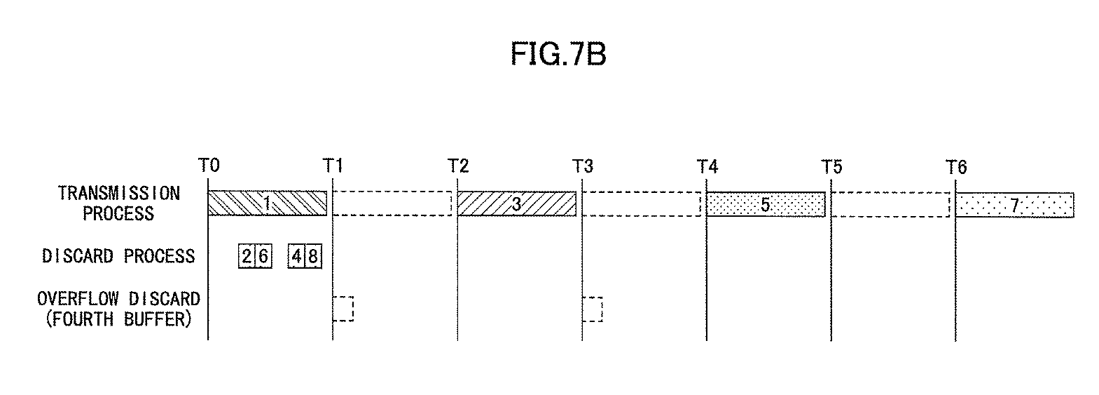

Under the same conditions as FIG. 6A, the sequential estimation operation according to an embodiment of the present invention is described with reference to FIGS. 7A and 7B. In this embodiment, the storage buffers 5 (frame buffers 5b) are referred to as first buffer, second buffer, third buffer, and fourth buffer, respectively.

Because a frame having an identification number 1 is transmitted at time T0, the frame data management part 5c of the first buffer moves up the storage order of the frame management data and updates the frame having the identification number 4.

The next estimated transmission time is time T2 obtained by adding the transmission time T0 of the frame having the identification number 1 to the transmission interval (in this embodiment, a single frame).

Because the transmission rule is a round robin method and a frame is stored in the head of the second buffer, the sequential buffer selection part 6 selects the second buffer as the buffer permitted to perform the next frame transmission.

The estimated transmission time T2 is earlier than the estimated discard time T3 because the estimated transmission time is T2 whereas the estimated discard time of the frame having the identification number 3 is T3. Accordingly, the transmission/discard control part 5e does not discard the frame having the identification number 3 but selects for transmission the frame having the identification number 3 stored in the second buffer. In addition, the transmission/discard control part 5e performs the next transmission estimation in the sequential estimation operation.

The next estimated transmission time is time T4 obtained by adding the transmission time T2 to the transmission interval. Because the transmission rule is a round robin method and a frame is not stored in the head of the second buffer, the sequential buffer selection part 6 selects the third buffer as the buffer permitted to perform the next frame transmission.

The estimated transmission time T4 is earlier than the estimated discard time T5 because the estimated transmission time is T4 whereas the estimated discarded time of the frame having the identification number 5 is T5. Accordingly, the transmission/discard control part 5e does not discard the frame having the identification number 5 but selects for transmission the frame having the identification number 5 stored in the third buffer. In addition, the transmission/discard control part 5e performs the next transmission estimation in the sequential estimation operation.

The next estimated transmission time is time T6 obtained by adding the transmission time T4 to the transmission interval. Because the transmission rule is a round robin method and a frame is stored in the head of the fourth buffer, the sequential buffer selection part 6 selects the fourth buffer as the buffer permitted to perform the next frame transmission.

The estimated transmission time T6 is later than the estimated discard time T2 because the estimated transmission time is T6 whereas the estimated discarded time of the frame having the identification number 2 is T2. Accordingly, the discard determination part determines that the frame having the identification number 2 is to be discarded and sends a request to discard the frame 2 to the transmission/discard control part 5e.

The transmission/discard control part 5e discards the frame having the identification number 2 based on the discard request from the discard determination part 5d. Accordingly, the frame, having the identification number 6 and being arranged second in the fourth buffer, moves up to the head of the fourth buffer. This frame is subjected to the sequential estimation of the fourth buffer. The estimated transmission time T6 is not updated because the frame 2 has been discarded.

Then, the estimated transmission time T6 is the same as the estimated discard time T6 because the estimated transmission time is T6 whereas the estimated discard time of the frame having the identification number 6 at the head of the fourth buffer is T6. Accordingly, the discard determination part 5d determines that the frame having the identification number 6 is to be discarded and sends a request to discard this frame to the transmission/discard control part 5e.

The transmission/discard control part 5e discards the frame having the identification number 6 from the fourth buffer based on the discard request from the discard determination part 5d. Accordingly, the frame having the identification number 7 and being stored second in the fourth buffer moves up to the head of the fourth buffer. This frame is subjected to the sequential estimation of the fourth buffer. The estimated transmission time T6 is not updated because the frame 6 has been discarded.

Then, the estimated transmission time T6 is earlier than the estimated discard time T7 because the estimated transmission time is T6 whereas the estimated discard time of the frame having the identification number 7 at the head of the fourth buffer is T7. Accordingly, the transmission/discard control part 5e does not discard the frame having the identification number 7 but selects the frame having the identification number 7 as the frame to be transmitted next. In addition, the transmission/discard control part 5e performs the next transmission estimation in the sequential estimation operation.

The next estimated transmission time is time T8 obtained by adding the transmission time T6 to the transmission interval. Because the transmission rule is a round robin method and a frame is stored in the head of the first buffer, the sequential buffer selection part 6 selects the first buffer as the buffer permitted to perform the next frame transmission.

The estimated transmission time T8 is later than the estimated discard time T4 because the estimated transmission time is T8 whereas the estimated discarded time of the frame having the identification number 4 is T4. Accordingly, the discard determination part 5d determines that the frame having the identification number 4 is to be discarded and requests discarding of the frame to the transmission/discard control part 5e.

The transmission/discard control part 5e discards the frame having the identification number 4 based on the discard request from the discard determination part 5d. The estimated transmission time T8 is not updated because only a frame is discarded.

Then, the sequential buffer selection part 6 makes a request for frame data of the frame(s) stored second (frame having moved up to the head) in the first buffer. However, the first buffer is excluded from the next operation because there are no frames stored in the first buffer.

Then, because the transmission rule is a round robin method and a frame is stored in the head of the fourth buffer, the sequential buffer selection part 6 selects the fourth buffer as the buffer permitted to perform the next frame transmission.

The estimated transmission time T8 is the same time as the estimated discard time T8 because the estimated transmission time is T8 whereas the estimated discarded time of the frame having the identification number 8 is T8. Accordingly, the discard determination part 5d determines that the frame having the identification number 8 is to be discarded and sends a request to discard the frame 8 to the transmission/discard control part 5e.

The transmission/discard control part 5e discards the frame having the identification number 8 based on the discard request from the discard determination part 5d. The estimated transmission time T8 is not updated because the frame is discarded.

The sequential estimation operation is terminated when all of the frames of all storage buffers 5 are subjected to the discard determination by the discard determination part 5d.

As described above, the sequential estimation operation is performed between the time T0 to the time T1. As illustrated in FIG. 7B, the transmitted frames and corresponding transmission times are illustrated in the top row and the frames discarded before reaching the estimated discard times and corresponding discard times are illustrated in the middle row. For reference, FIGS. 7A and 7B illustrate the frames (frames having identification numbers 9 and 11) prevented from being discarded due to overflow with dotted lines and estimated discard times corresponding to the frames.

Accordingly, the fourth buffer can have available capacity equivalent to three frames at the time T2. Unlike the comparative example, the frames having identification numbers 9 and 11 can be stored in the first buffer and prevented from being discarded.

Hence, the transmission apparatus 10 according to an embodiment of present invention can prevent subsequent transmission frames from being discarded due to overflow caused by not discarding the frames having a retain time that surpasses the permissible delay time. Particularly, with the transmission apparatus 10 according to an embodiment of the present invention, the storage buffers 5 can be efficiently used. Thus, the storage capacity of the storage buffers 5 can be reduced.

### Second Embodiment

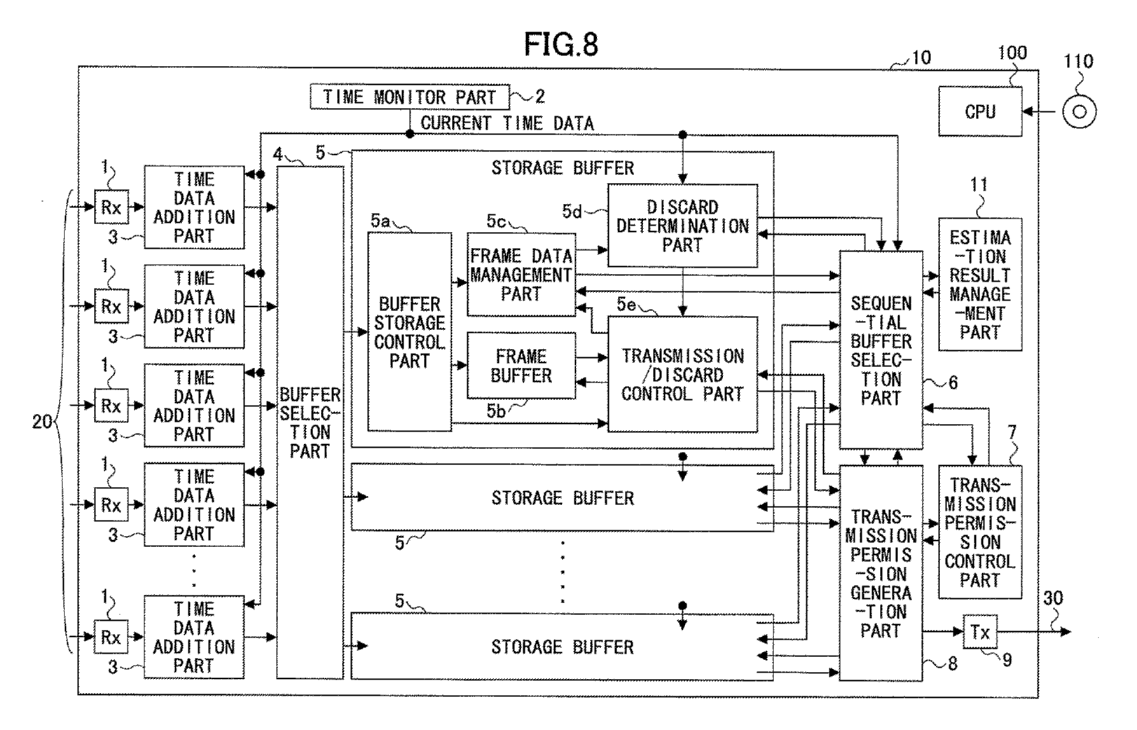

FIG. 8 illustrates the transmission apparatus 10 according to a second embodiment of the present invention. The transmission apparatus 10 of FIG. 8 includes an estimation result management part 11 for storing transmission order data from the sequential buffer selection part 6. The transmission order data include data pertaining to the transmission order and the estimated transmission time that are estimated by the sequential buffer selection part 6. The transmission order data are input to the estimation result management part 11 whenever the sequential estimation operation is performed. Further, in a case where a frame is read from the frame buffer 5b, the estimation result management part 11 updates the transmission order data by moving up the transmission order of each frame.

In the second embodiment, whenever a frame is transmitted, the transmission permission control part 7 reports the transmission of the frame to the sequential buffer selection part 6. Further, the sequential buffer selection part 6 obtains transmission order data (data for identifying the frame permitted for the next transmission) from the estimation result management part 11 and reports data of the frame to be permitted to be transmitted to the transmission permission control part 7.

Further, whenever a frame is newly stored in the frame buffer 5b, the sequential buffer selection part 6 obtains storage order data of the frame newly stored in the frame buffer 5b (new frame) from the frame data management part 5c. The frame buffer 5b storing the new frame may be referred to as a “new storage buffer”. Further, whenever a frame is stored in the frame buffer 5b, the sequential buffer selection part 6 obtains storage order data of each frame stored in the frame buffers 5b from the frame data management part 5c. Further, whenever a frame is stored in the frame buffers 5b, the sequential buffer selection part 6 obtains transmission order data of each frame from the estimation result management part 11.

The sequential buffer selection part 6 calculates the transmission order of the new frame based on the priority of the new frame's storage buffer, the storage order of the new frame, the priority of the estimated current position buffer, the storage order of the estimated current position frame, the priority of each buffer, and the storage order of each frame. The term “estimated current position frame” indicates the last frame according to an estimated transmission order of frames obtained whenever the sequential estimation operation is performed. The term “estimated current position buffer” indicates the last frame buffer 5b that is selected whenever the sequential estimation operation is performed. The estimated current position buffer is for storing the estimated current position frame therein. The sequential buffer selection part 6 calculates the estimated transmission time of a frame to be transmitted after the new frame according to the calculated transmission order of the new frame and outputs the calculated estimated transmission time to the discard determination part 5d.

In a case where there is a change in the transmission order of frames due to storing the new frame in the new frame's storage buffer, the sequential buffer selection part 6 updates the transmission order data of the estimation result management part 11 with the newly calculated transmission order and estimated transmission time.

It is to be noted that the only differences in the configuration of the transmission apparatus 10 of the first embodiment and the transmission apparatus 10 of the second embodiment is that the estimation result management part 11 is added to the transmission apparatus 10 of the second embodiment and that additional functions are provided to the sequential buffer selection part 6.

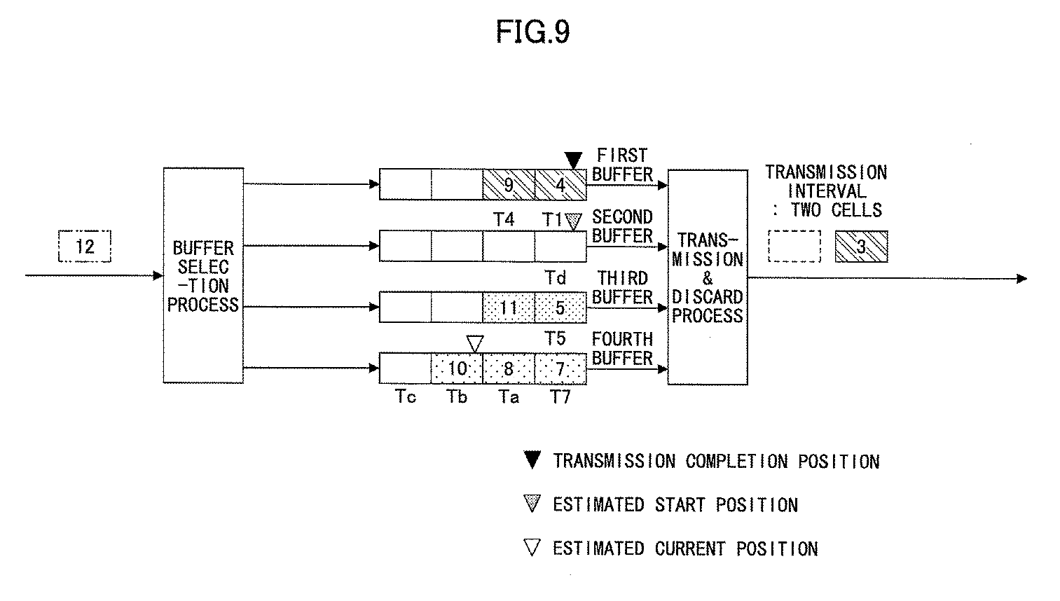

Next, a sequential estimation correction operation is described with reference to FIGS. 9-15. The sequential estimation correction operation is performed by determining whether there is any change in the results of the sequential estimation operation due to the new frame being stored in the new storage buffer and making corrections according to the determination.

In the following embodiment, the transmission apparatus 10 includes four storage buffers 5 (frame buffers 5b). The storage buffers 5 are referred to as first buffer, second buffer, third buffer, and fourth buffer.

In the following embodiment, the term “transmission completion position buffer” indicates a buffer permitted to be transmitted most recently (immediately before), and the term “estimated start position buffer” indicates a buffer to be selected with highest priority after a transmission completion position buffer. Further, the term “estimated current position storage order” indicates the storage order of the estimated current position frame stored in the estimated current position buffer.

For the sake of simplifying the explanation, FIGS. 9-14B illustrate a case where the frames received by the transmission apparatus 10 have fixed length (e.g., ATM (Asynchronous Transfer Mode), and the sequential transmission frames (cells) are transmitted at a minimum transmission interval equivalent to that of a single frame.

According to the embodiment illustrated in FIGS. 9-14B, the transmission apparatus 10 has four buffers (first buffer, second buffer, third buffer, fourth buffer). The number of frames that can be stored in each buffer (buffer capacity) is four. The frames are illustrated with different hatching in correspondence with the buffers. For the sake of convenience, each frame is assigned a number for identifying the frame (identification number). The time data Tn (n=1, 2, . . . ) illustrated below the frames of the first-fourth buffers represent the estimated discard time calculated by adding the permissible delay time to reception time.

In FIG. 9, frames having identification numbers 4 and 9 are stored in the first buffer, frames having identification numbers 5 and 11 are stored in the third buffer, and frames having identification numbers 7, 8, and 10 are stored in the fourth buffer.

Further, in FIG. 9, a frame having identification number 3 has been most recently (immediately before) transmitted from the first buffer. FIG. 9 illustrates a sate where the sequential estimation operation is completed for all of the frames stored in the first-fourth buffers according to a round-robin rule.

In FIG. 9, the second buffer is selected as the buffer to be selected with the highest priority (estimated start position buffer) according to the round-robin rule because a frame (in this embodiment, the frame having identification number 3) has been transmitted from the first buffer (transmission completion position buffer) most recently. Further, according to the sequential estimation operation, the frame having identification number 10 in the fourth buffer is estimated to be the last frame (estimated current position frame) according to the transmission order. Accordingly, the fourth buffer is the estimated current position buffer. It is to be noted that the selection of buffers is performed according to the round-robin rule even for buffers without any frames stored therein.

In the state illustrate in FIG. 9, the estimation result management part 11 manages the priority of each buffer according to the round-robin rule (also referred to as “estimated priority”) in which the estimated start position buffer (in this embodiment, second buffer) is the starting point. Thus, in the state illustrated in FIG. 9, the priority of the buffers is expressed as “second buffer>third buffer>fourth buffer>first buffer”. The estimation result management part 11 manages data of the estimated current position buffer and the data of the estimated current position storage order.

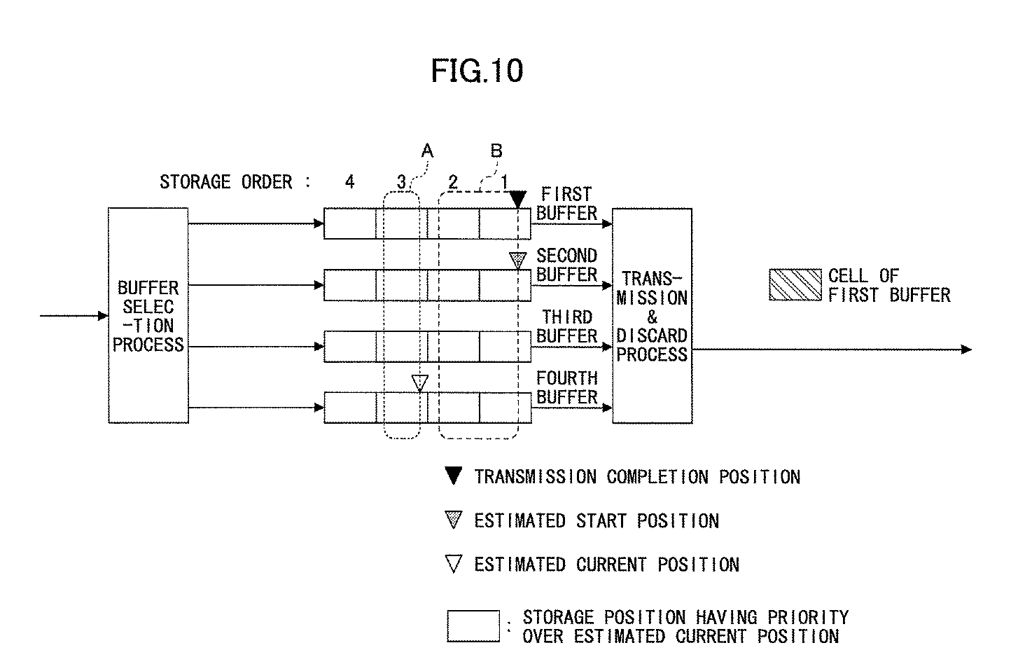

In FIG. 10, positions of the storage orders 1 and 2 of the first buffer, the storage orders 1-3 of the second buffer, the storage orders 1-3 of the third buffer, and the storage orders 1-3 of the fourth buffer are positions selected with priority with respect to the estimated current position according to the round-robin rule. That is, in a case where a new frame is stored in the storage positions selected with priority, the storage positions could change according to the results of the sequential estimation operation performed immediately before receiving the new frame.

The storage positions selected with priority are positions of the estimated start position through the estimated current position which are selected according to the round-robin rule without moving up the storage order. Further, the estimated start position is the position of the storage order in which a head frame of an estimated start position buffer is stored. The estimated current position is a position of the storage order in which an estimated current position frame of an estimated current position buffer is stored.

As illustrated in FIG. 9, the transmission apparatus 10 newly receives a frame having an identification number 12. In a case where the frame having identification number 12 (new frame) is stored in a storage position selected with priority, the storing of the new frame changes the results of the sequential estimation operation. Accordingly, the results of the sequential estimation operation are to be corrected.

Next, procedures of correcting the results of the sequential estimation operation are described.

First, the sequential buffer selection part 6 obtains data of estimated priority of each buffer, data of the estimated current position buffer, and data of the estimated current position storage order from the estimation result management part 11. The sequential buffer selection part 6 obtains data of the new frame's storage buffer and data of the storage order of the new frame from the frame data management part 5c.

The sequential buffer selection part 6 determines whether there is a change in the results of the sequential estimation operation based on the conditions indicated in the following Table 1. In FIG. 10, the region encompassed by dotted line A indicates a range where “storage order of estimated current position of frame=storage order of new frame”. The determination whether the results of the sequential estimation operation are to be corrected is based on the size relationship (greater than or less than relationship) between the estimated current position buffer and the new storage buffer. In FIG. 10, the region encompassed by dotted line B indicates a range where “storage order of estimated current position frame>storage order of new frame”).

TABLE 1

| | | DETERMINATION |
|---|---|---|
| CONDITION | CONTENT | RESULT |
| 1 | STORAGE ORDER OF | CHANGE |
| | NEWFRAME < STORAGE | |
| | ORDER OF ESTIMATED | |
| | CURRENT FRAME | |
| 2 | STORAGE ORDER OF | CHANGE |
| | NEWFRAME = STORAGE | |
| | ORDER OF ESTIMATED | |
| | CURRENT FRAME ESTIMATED | |
| | PRIORITY OF NEWSTORAGE | |
| | BUFFER ≧ ESTIMATED | |
| | PRIORITY OF ESTIMATED | |
| | CURRENT BUFFER | |
| 3 | STORAGE ORDER OF | NO |
| | NEWFRAME = STORAGE | CHANGE |
| | ORDER OF ESTIMATED | |
| | CURRENT FRAME ESTIMATED | |
| | PRIORITY OF NEWSTORAGE | |
| | BUFFER < ESTIMATED | |
| | PRIORITY OF ESTIMATED | |
| | CURRENT BUFFER | |
| 4 | STORAGE ORDER OF | NO |
| | NEWFRAME > STORAGE | CHANGE |
| | ORDER OF ESTIMATED | |
| | CURRENT FRAME | |

In a case where the sequential buffer selection part 6 determines that there is a change in the results of the sequential estimation operation, the sequential buffer selection part 6 verifies the conditions in the following Table 2 starting from the sequential estimation current position to a one having a young storage order. Then, the sequential buffer selection part 6 identifies a change position (transmission order) that satisfies condition 5 or condition 6 of Table 2. Then, the new frame is inserted in the transmission order next after the identified change position.

TABLE 2

| CONDITION | CONTENT |
|---|---|
| 5 | ESTIMATED PRIORITY OF REFERRED BUFFER > |
| | ESTIMATED PRIORITY OF NEWSTORAGE BUFFER |
| | STORAGE ORDER OF REFERRED FRAME ≦ |
| | STORAGE ORDER OF NEWFRAME |
| 6 | ESTIMATED PRIORITY OF REFERRED BUFFER ≦ |
| | ESTIMATED PRIORITY OF NEWSTORAGE BUFFER |
| | STORAGE ORDER OF REFERRED FRAME ≦ |
| | (STORAGE ORDER OF NEWFRAME) − 1 |

In the embodiment illustrated in FIG. 9, the estimated start position buffer is the second buffer, the estimated current position buffer is the fourth buffer, and the storage order of the estimated current position frame is third (third frame). In this embodiment, the estimated priority of the buffers according to the round-robin rule is expressed as “second buffer>third buffer>fourth buffer>first buffer”.

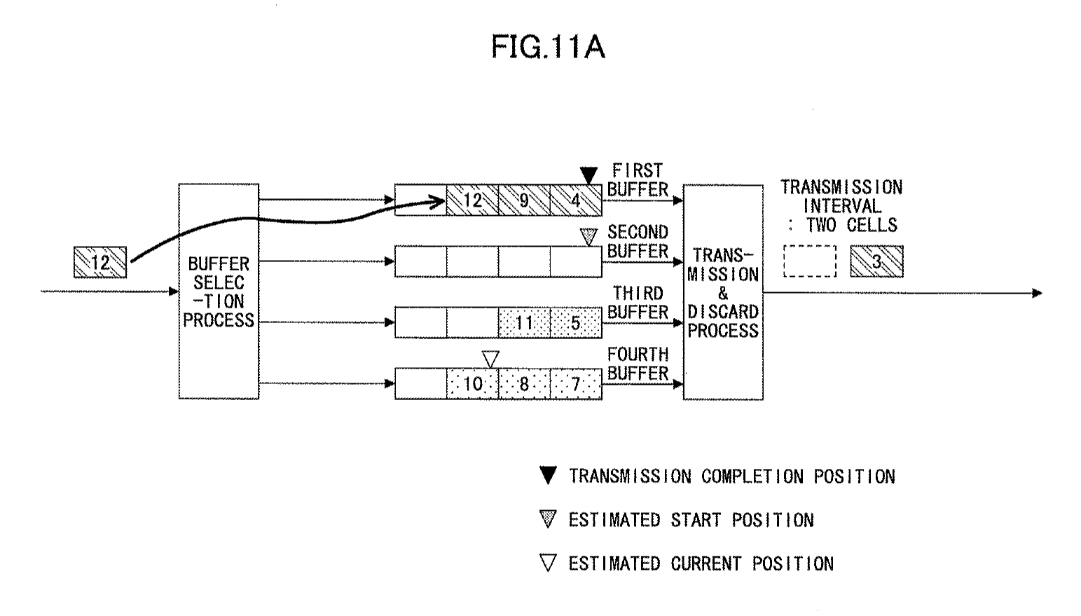

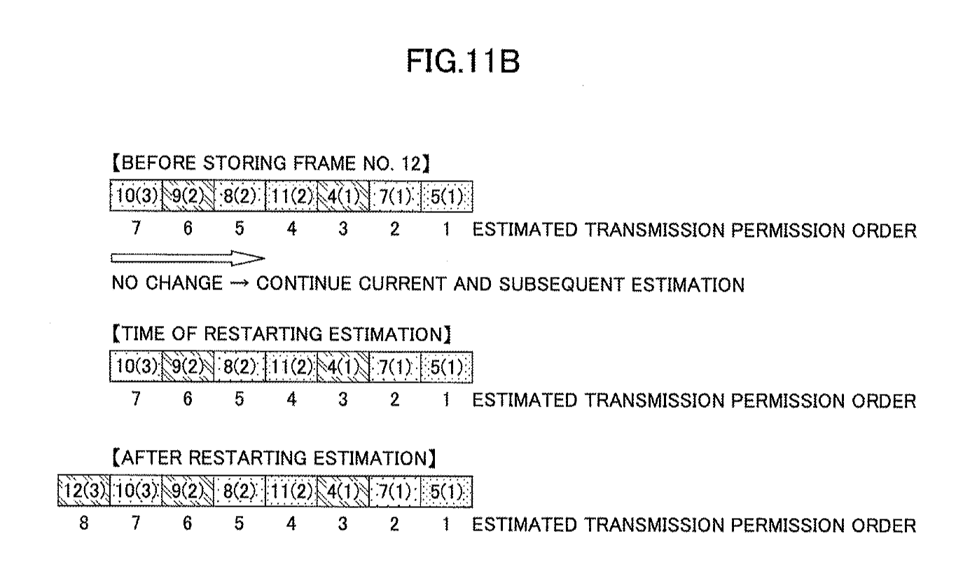

For example, with reference to FIGS. 11A and 11B, the following processes are performed in a case where a frame having an identification number 12 (new frame) is stored in the first buffer (new storage buffer).

The sequential buffer selection part 6 detects that the new storage buffer is the first buffer and the storage order of the new frame is third based on the data of the new storage buffer and the storage order of the new frame obtained from the frame data management part 5c.

Further, the sequential buffer selection part 6 detects that the estimated current position buffer is the fourth buffer and the storage order of the estimated current position frame is third based on the data of the estimated current position buffer and the storage order of the estimated current position obtained from the estimation result management part 11.

Then, because the storage orders of both the new storage frame and the estimated current position frame are third and the condition 2 or condition 3 of Table 1 is satisfied, the sequential buffer selection part 6 compares priorities of the buffers.

The sequential buffer selection part 6 determines that the estimated priority of the new storage buffer (first buffer) is lower (less) than the estimated priority of the estimated current position buffer (fourth buffer) based on the data of the estimated priorities of the buffers obtained from the estimation result management part 11.

Accordingly, because condition 3 of Table 1 is satisfied, the sequential buffer selection part 6 determines that there is no change in the results of the sequential estimation operation and the estimation result management part 11 does not update the transmission order data stored therein. Thus, the sequential estimation operation is to be continued as before. It is to be noted that the frame having the identification number 12 becomes eighth (eighth frame) which is next after the frame having the identification number 10. The estimated transmission time of the frame having the identification number 12 is obtained by adding the transmission interval time to the estimated transmission time of the frame having the identification number 10.

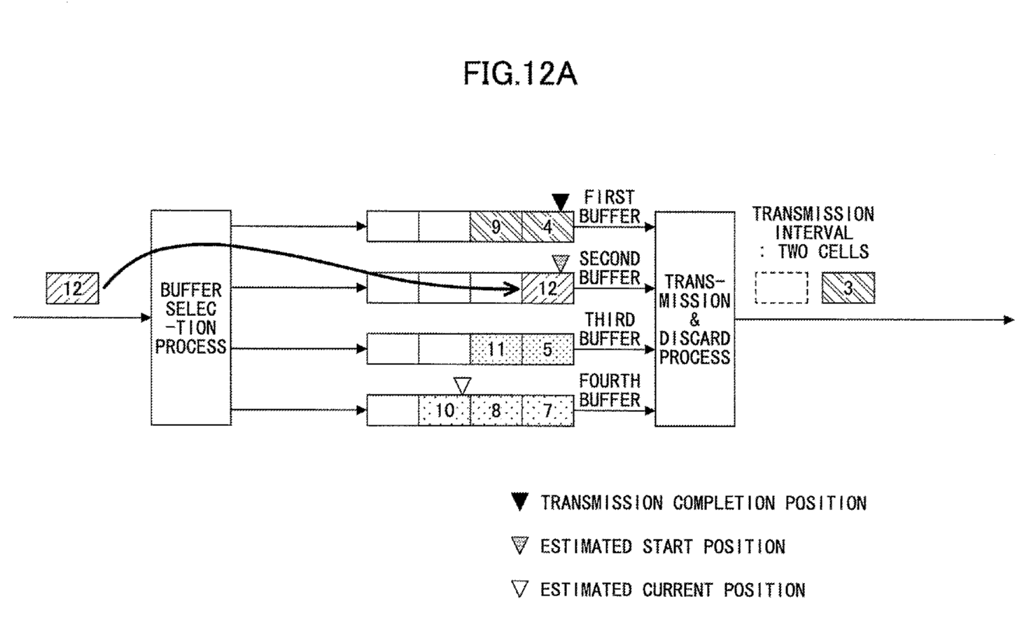

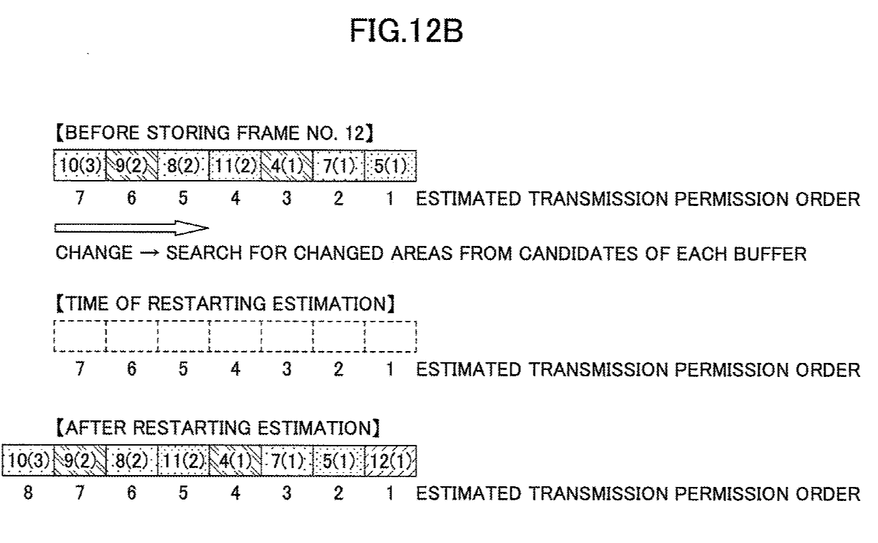

For example, with reference to FIGS. 12A and 12B, the following processes are performed in a case where a frame having an identification number 12 (new frame) is stored in the second buffer (new storage buffer).

The sequential buffer selection part 6 determines that the new storage buffer is the second buffer and the storage order of the new storage frame is first based on the data of the new storage buffer and the storage order of the new storage frame obtained from the frame data management part 5c.

Further, the sequential buffer selection part 6 detects that the estimated current position buffer is the fourth buffer and the storage order of the estimated current position frame is third based on the data of the estimated current position buffer and the storage order of the estimated current position obtained from the estimation result management part 11.

The sequential buffer selection part 6 compares the storage order of the new storage frame and the storage order of the estimated current position frame and determines that the storage order of the new storage frame is earlier (less) than the storage order of the estimated current position frame.

Accordingly, because condition 1 of Table 1 is satisfied, the sequential buffer selection part 6 determines that there is a change in the results of the sequential estimation operation. Thus, the sequential buffer selection part 6 refers to the results of the sequential estimation operation starting from the frame of the estimated current position to the frames having earlier (less) transmission order and identifies a changed location (transmission order) that satisfies the condition 5 or the condition 6 of Table 2.

The sequential buffer selection part 6 determines the condition of the changed location corresponding to each referred to buffer based on the storage order of the new storage frame and the estimated priority of the buffer. That is, because the estimated priority of the first buffer is equal to or less than the estimated priority of the new storage buffer (second buffer), the condition can be satisfied for the first buffer if the storage order of the referred to frame is equal to or less than 0 (storage order of the new frame −1) according to the condition 6 of Table 2. Likewise, the condition can be satisfied for the second, third, and fourth buffers if the storage order of the referred to frame is equal to or less than the 0 (storage order of the new frame −1) according to the condition 6 of Table 2.

Then, the sequential buffer selection part 6 searches for a candidate storage order satisfying the determined condition of the changed location (in this case, storage order 0) with respect to each buffer. Because there is no candidate satisfying the determined condition, a new frame is inserted in the head of the estimated transmission order, so that the sequential buffer selection part 6 can restart the sequential estimation operation from the head of the transmission order. It is to be noted that the estimated transmission time of the frame having the identification number 12 becomes the estimated transmission time of the frame having the identification number 5 (first frame in the estimated transmission order). Thus, the new estimated transmission time of the frame having the identification number 5 is obtained by adding the transmission interval to the estimated transmission time of the frame having the identification number 12.

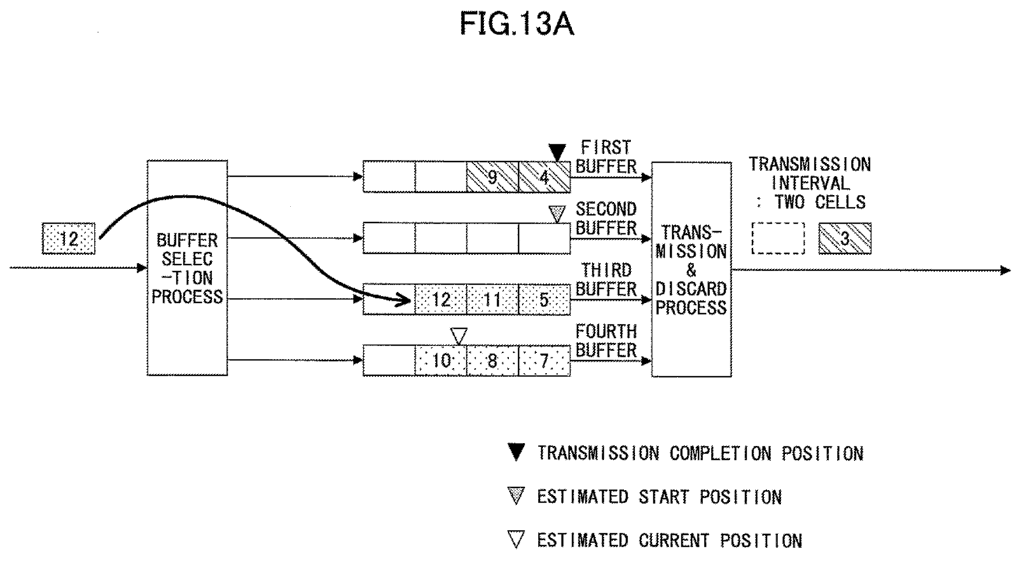

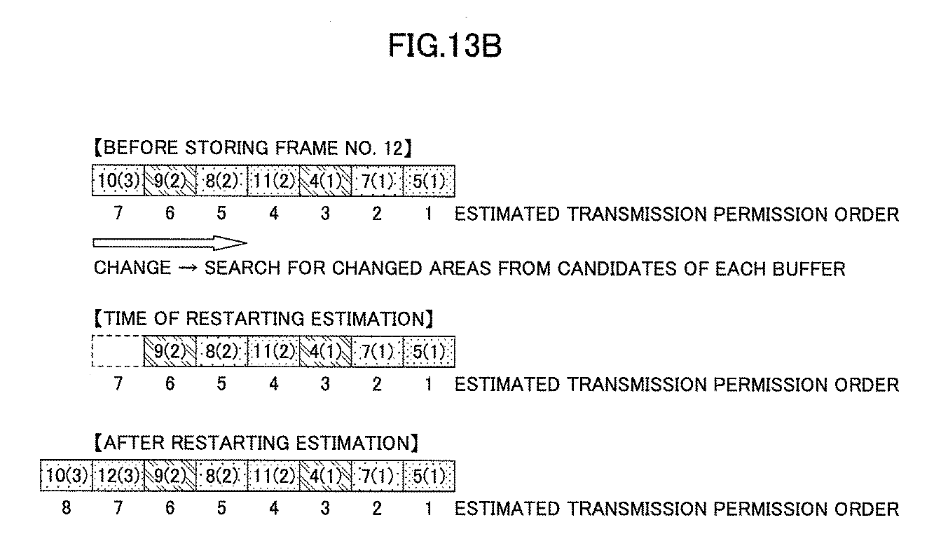

For example, with reference to FIGS. 13A and 13B, the following processes are performed in a case where a frame having an identification number 12 (new frame) is stored in the third buffer (new storage buffer).

The sequential buffer selection part 6 detects that the new storage buffer is the third buffer and the storage order of the new frame is third based on the data of the new storage buffer and the storage order of the new frame obtained form the frame data management part 5c.

Further, the sequential buffer selection part 6 detects that the estimated current position buffer is the fourth buffer and the storage order of the estimated current position frame is third based on the data of the estimated current position buffer and the storage order of the estimated current position obtained from the estimation result management part 11.

Then, because the storage orders of both the new storage frame and the estimated current position frame are third and the condition 2 or condition 3 of Table 1 is satisfied, the sequential buffer selection part 6 compares priorities of the buffers.

The sequential buffer selection part 6 determines that the estimated priority of the new storage buffer (third buffer) is higher (greater) than the estimated priority of the estimated current position buffer (fourth buffer) based on the data of the estimated priorities of the buffers obtained from the estimation result management part 11.

Accordingly, because condition 3 of Table 5 is satisfied, the sequential buffer selection part 6 determines that there is a change(s) in the results of the sequential estimation operation.

Thus, the sequential buffer selection part 6 refers to the results of the sequential estimation operation starting from the frame of the estimated current position to the frames having earlier (less) transmission order and identifies a changed location (transmission order) that satisfies the condition 5 or the condition 6 of Table 2.

The sequential buffer selection part 6 determines the condition of the changed location corresponding to each referred buffer based on the storage order of the new storage frame and the estimated priority of the buffer. That is, because the estimated priority of the first buffer is equal to or less than the estimated priority of the new storage buffer (third buffer), the condition can be satisfied for the first buffer if the storage order of the referred frame is equal to or less than the 0 (storage order of the new frame −1) according to the condition 6 of Table 2. Likewise, the condition can be satisfied for the third, and fourth buffer if the storage order of the referred frame is equal to or less than the second (storage order of the new frame −1) according to the condition 6 of Table 2. Further, because the estimated priority of the second buffer is equal to or higher (greater) than the estimated priority of the new storage buffer (third buffer), the condition can be satisfied for the second buffer if the storage order of the referred frame is equal to or less than the third (storage order of the new frame) according to the condition 5 of Table 2.

Then, the sequential buffer selection part 6 searches for a candidate storage order satisfying the determined condition of the changed location (in this case, storage order 2 (second) with respect to the first, third, and fourth buffers, and storage order 3 (third) with respect to the second buffer) with respect to each buffer. Because the second frame of the first buffer can be detected as the candidate satisfying the determined condition, a new frame is inserted in the estimated transmission order (in this case, seventh frame), so that the sequential buffer selection part 6 can restart the sequential estimation operation from the frame having the transmission order 7 (seventh frame). It is to be noted that the estimated transmission time of the frame having the identification number 12 becomes the estimated transmission time of the frame having the identification number 10 (seventh frame in the estimated transmission order). Thus, the new estimated transmission time of the frame having the identification number 10 is obtained by adding the transmission interval to the estimated transmission time of the frame having the identification number 12.

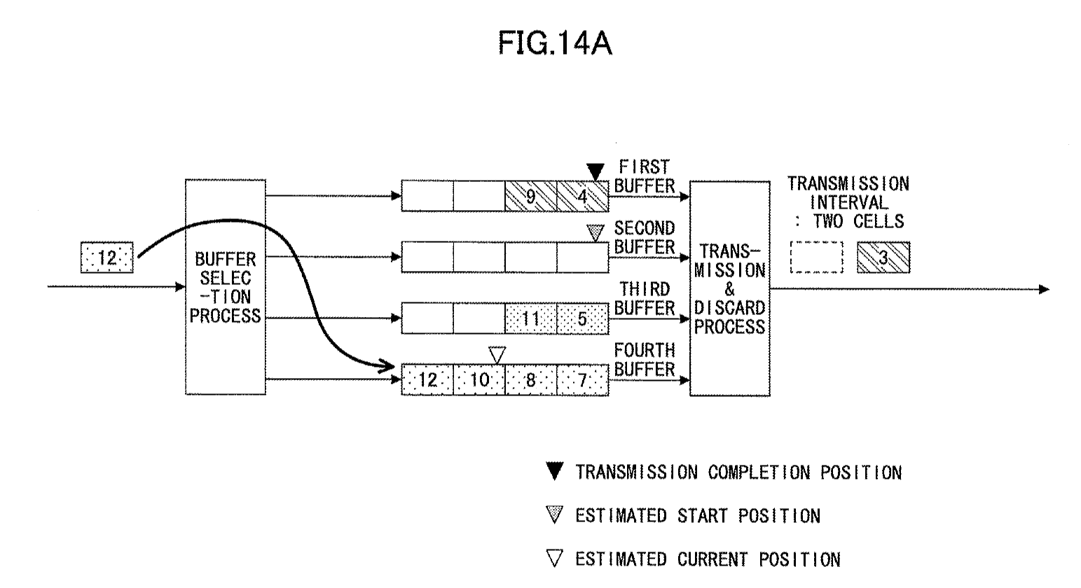

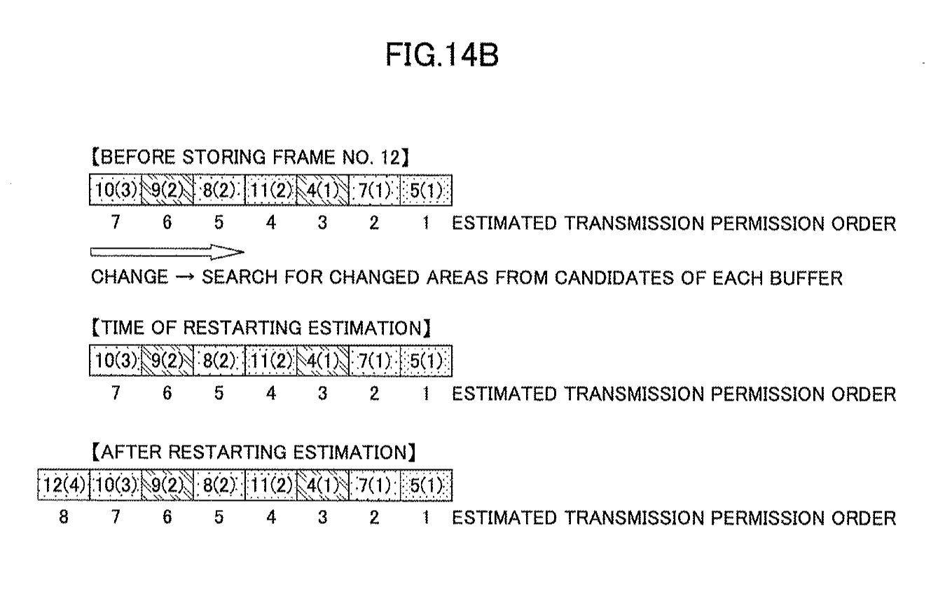

For example, with reference to FIGS. 14A and 14B, the following processes are performed in a case where a frame having an identification number 12 (new frame) is stored in the fourth buffer (new storage buffer).

The sequential buffer selection part 6 detects that the new storage buffer is the fourth buffer and the storage order of the new frame is fourth based on the data of the new storage buffer and the storage order of the new frame obtained form the frame data management part 5c.

Further, the sequential buffer selection part 6 detects that the estimated current position buffer is the fourth buffer and the storage order of the estimated current position frame is third based on the data of the estimated current position buffer and the storage order of the estimated current position obtained from the estimation result management part 11.

In comparing the storage order of the new frame and the estimated current position frame, the sequential buffer selection part 6 determines that the estimated priority of the new frame is later (greater) than the estimated current position frame.

Accordingly, because condition 4 of Table 1 is satisfied, the sequential buffer selection part 6 determines that there is no change in the results of the sequential estimation operation. Thus, the sequential estimation operation is to be continued as before. It is to be noted that the frame having the identification number 12 becomes eighth (eighth frame) which is next after the frame having the identification number 10. The estimated transmission time of the frame having the identification number 12 is obtained by adding the transmission interval time to the estimated transmission time of the frame having the identification number 10.

Although the round-robin rule is used as the transmission rule in the above-described embodiments, strict priority (SR) may also be used. Thus, in a case where the strict priority is set as “first buffer>second buffer>third buffer>fourth buffer”, the priority starting from the estimated start position buffer does not need to be changed when performing the sequential estimation correction operation. That is, the sequential estimation operation is performed by using the strict priority as the estimated priority.

Hence, because transmission order data are stored in the estimation result management part 11 of the transmission apparatus 10 according to the second embodiment, the transmission order data can be updated by simply moving up the transmission order in a case where there the storage status of the storage buffers 5 is changed by transmission of frames. Further, in a case where the storage status of the storage buffers 5 is changed by storage of frames, the sequential estimation operation can be performed by identifying the changed location of the results of the sequential estimation operation (location of the results of the sequential operation changed by the storage of frames) and performing the sequential estimation operation only on the frame(s) having a transmission order next after the changed location. With the transmission apparatus 10 according to the second embodiment, the performance of the sequential estimation operation can be improved whenever there is a change in the storage status in the storage buffers 5. Thus, processing can be performed with greater speed with the transmission apparatus 10 of the second embodiment of the present invention.

### Third Embodiment

Next, a transmission apparatus 10 according to a third embodiment of the present invention is described with reference to FIG. 1. The frame data management part 5c manages data pertaining to the frame length of the frames stored in the frame buffer 5b (frame length data). Further, the frame data management part 5c reports frame length data of a frame corresponding to a storage number designated by the sequential buffer selection part 6 to the sequential buffer selection part 6. The frame length data includes data indicating, for example, frame length or the number of segments in a case where a frame is divided into segments having a predetermined length.

The transmission permission control part 7 calculates line availability time based on the frame length data reported from the sequential buffer selection part 6. The line availability time is the time in which a line is available during a period starting from the completion of transmission of a frame to the start of transmission of the next frame. Further, the transmission permission control part 7 reports data of the calculated line availability time (line availability time data) to the sequential buffer selection part 6.

The line availability time may be calculated based on the following Formula 1. In Formula 1, the line usage rate of the transmission path 30 is indicated as “R %”, and the line availability time from the time of completing transmission of a frame having a frame length of L1 bytes to the time of starting transmission of the next frame.

[FORMULA 1]

M1=L1×(1−R/100) (1)

The sequential buffer selection part 6 obtains frame length data of a frame permitted to be transmitted according to the sequential estimation operation from the frame data management part 5c and reports the frame length data to the transmission permission control part 7. Further, the sequential buffer selection part 6 obtains line availability time data from the transmission permission control part 7 and calculates the estimated transmission time of the next frame for performing the sequential estimation operation based on the line availability time data and the frame length data obtained from the transmission permission control part 7 and the frame data management part 5c.

More specifically, the estimated transmission time of the next frame is calculated according to the following Formula 2. In Formula 2, the period of time from the starting of the transmission of a frame having a frame length L1 to the completion of the transmission of the frame is expressed as “L1/N (the handling of decimals is optional) and the line availability time is expressed as “M1 bytes”. Accordingly, in a case where a frame having a frame length of L1 bytes is transmitted at time Tₙ, the transmission completion time of the frame is “Tₙ+L1/N”.

[FORMULA 2]

Tₙ₊₁=Tₙ+L1/N+M1 (2)

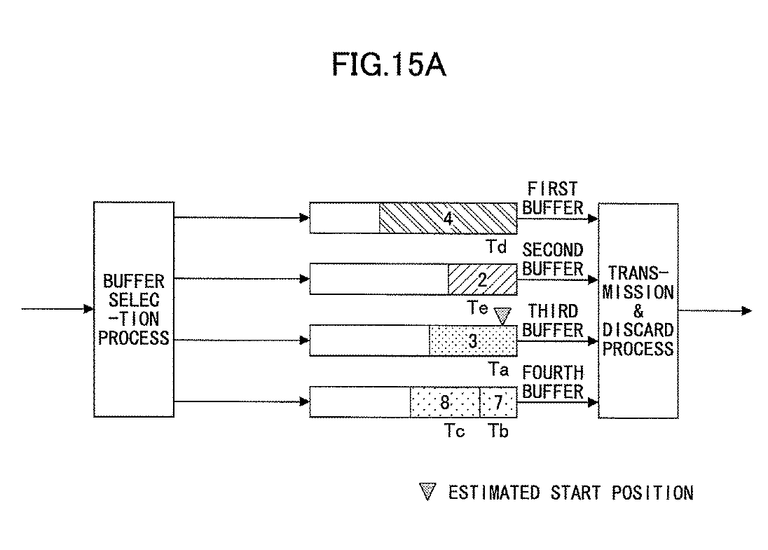

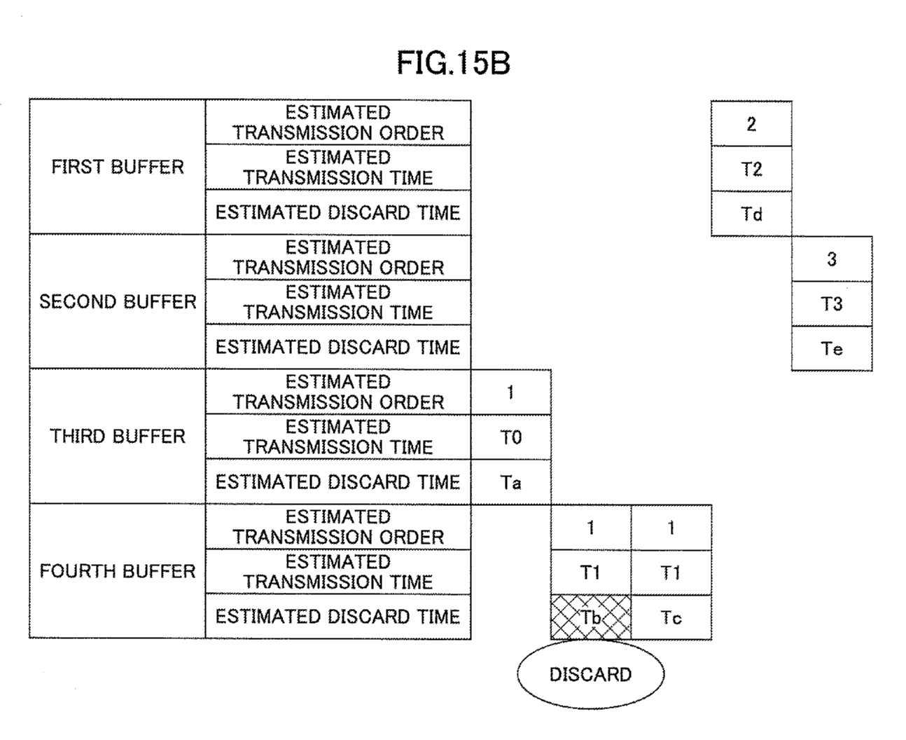

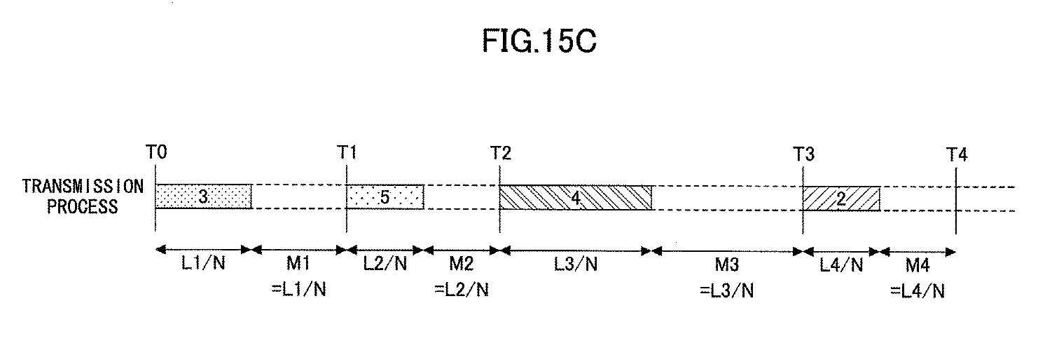

In the example illustrated with FIGS. 15A-15C, a frame having a frame length L3 bytes is stored in the first buffer, a frame having a frame length L4 bytes is stored in the second buffer, and a frame having a frame length L1 bytes is stored in the third buffer. Further, a frame having a frame length L2 bytes and a frame having a frame length L5 bytes (this frame is, however, discarded because the estimated discard time Tb is earlier than the estimated transmission time T1) are stored in the fourth buffer. Further, FIG. 15C illustrates the unit of time required for transmitting a data amount N. In this example, the line usage rate is 50%, the estimated start position buffer is the third buffer, and the transmission rule is the round-robin rule.

In a case where a frame having an identification number 3 (stored in the third buffer) is transmitted at the time T0, the estimated transmission time T1 of the next frame to be transmitted (in this example, a frame having an identification number 5 of the fourth buffer) is expressed as “T0+L1/N+L1/N”. Likewise, the estimated transmission time T2 of the next frame to be transmitted after the frame having an identification number 5 (in this example, a frame having an identification number 4 of the first buffer) is expressed as “T1+L2/N+L2/N”. Further, the estimated transmission time T3 of the next frame to be transmitted after the frame having an identification number 4 (in this example, a frame having an identification number 2 of the second buffer) is expressed as “T2+L3/N+L3”.

Although the third embodiment is applied to the configuration illustrated in FIG. 1, the third embodiment may be applied to the configuration illustrated in FIG. 8. In this case, the transmission permission control part 7 is configured to provided a function of calculating a line availability time. Alternatively, the function of calculating the line availability time may be provided to the estimation result management part 11.

The differences between the transmission apparatus 10 of the third embodiment and the transmission apparatuses 10 of the first and second embodiments are that frame length data are stored in the frame data management part 5c and that new functions are provided to the sequential buffer selection part 6, the transmission permission control part 7, or the estimation result management part 10 as described above.

Hence, with the above-described embodiments of the transmission apparatus 10 the sequential estimation operation and the sequential estimation correction operation can be performed even in a case where received frames do not have the same frame length (i.e. variable length frames).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission apparatus for receiving frames from one transmission path, storing the frames in a plurality of buffers, and transmitting the frames to another transmission path, the transmission apparatus comprising:
an estimated discard time determination part configured to determine an estimated discard time of the frames stored in the plural buffers;
a transmission order determination part configured to determine a transmission order of the frames;
an estimated transmission time calculation part configured to calculate an estimated transmission time of each of the frames based on the transmission order; and
a discard control part configured to discard a target frame from the frames stored in the plural buffers based on the estimated transmission time and the estimated discard time in a case where the estimated discard time of the target frame is the same as or earlier than the estimated transmission time of the target frame.

2. A transmission apparatus for receiving frames from one transmission path, storing the frames in a plurality of buffers, and transmitting the frames to another transmission path, the transmission apparatus comprising:
a transmission order determination part configured to determine a transmission order of the frames;
a sequential buffer selection part configured to determine an estimated discard time of the frames stored in the plural buffers, calculate an estimated transmission time of each of the frames based on the transmission order, and select a target buffer from the plural buffers according to a predetermined rule;
a discard control part configured to discard a target frame from the frames stored in the plural buffers based on the estimated transmission time and the estimated discard time in a case where the estimated discard time of the target frame is the same as or earlier than the estimated transmission time of the target frame;
a frame data management part configured to store data pertaining to a reception time of the frames and data pertaining to a storage order of the frames;
a discard determination part configured to determine whether the target frame is to be discarded based on the estimated discard time and the estimated transmission time of the target frame and output a discard request to the discard control part in a case where the target frame is determined to be discarded;
wherein the sequential buffer selection part is configured to designate the storage order of the frames, output the designated storage order to the frame data management part, calculate the estimated transmission time of the frames in correspondence with the designated storage order designated, and output the estimated transmission time to the discard determination part; and
wherein the frame data management part is configured to output the reception time of the frames in correspondence with the designated storage order.

3. The transmission apparatus as claimed in claim 2, wherein in a case where the discard determination part outputs the discard request, the sequential buffer selection part is configured to designate a next frame having a storage order subsequent to the storage order of the target frame, output data pertaining to the storage order of the next frame to the frame data management part, and output the estimated transmission time of the target frame as the estimated transmission time of the next frame.

4. The transmission apparatus as claimed in claim 2, wherein in a case where the discard determination part does not output the discard request, the sequential buffer selection part is configured to select a next buffer subsequent to the buffer storing the target frame according to the predetermined rule, designate another target frame stored in the next buffer, output data pertaining to the storage order of the other target frame to the frame data management part, calculate the estimated transmission time of the designated other target frame by adding the estimated transmission time of the target frame to a transmission interval of the frames, and output the estimated transmission time of the designated other target frame to the discard determination part.

5. The transmission apparatus as claimed in claim 2, wherein in a case where no frame is stored in the target buffer, the sequential buffer selection part is configured to select a next buffer subsequent to the target buffer based on the predetermined rule.

6. The transmission apparatus as claimed in claim 2, further comprising:
an estimation result management part configured to store data pertaining to the transmission order and data pertaining to the estimated transmission time with respect to each frame,
wherein in a case where a new frame is stored in a new target buffer, the sequential buffer selection part is configured to obtain data pertaining to the storage order of the new frame and the storage order of the frames of the plural buffers from the frame data management part, obtain data pertaining to the storage order and data pertaining to the estimated transmission time from the estimation result management part, calculate the transmission order and the estimated transmission time of the new frame, and output the calculated estimated transmission order of the new frame to the discard determination part.

7. The transmission apparatus as claimed in claim 6, wherein the estimation result management part is configured to move up the stored transmission order of each frame in a case where a frame is read from the target buffer.

8. The transmission apparatus as claimed in claim 2, wherein the sequential buffer control part is configured to calculate an interval of the transmission time of the frames by adding a first period starting from a time of completing transmission of the target frame to a time of starting transmission of a next frame and a second period starting from a time of starting transmission of a frame having a predetermined frame length and a time of completing transmission of the frame having the predetermined frame length, wherein the first period is calculated based on a line usage rate of the other transmission path and a frame length of the target frame, wherein the second period is calculated based on data of the predetermined frame length.

9. A transmission method for receiving frames from one transmission path, storing the frames in a plurality of buffers, and transmitting the frames to another transmission path, the transmission method comprising:
determining an estimated discard time of the frames stored in the plural buffers;
determining a transmission order of the frames;
calculating an estimated transmission time of each of the frames based on the transmission order; and
discarding a target frame from the frames stored in the plural buffers based on the estimated transmission time and the estimated discard time in a case where the estimated discard time of the target frame is the same as or earlier than the estimated transmission time of the target frame.

10. A non-transitory computer-readable recording medium on which a program is recorded for causing a computer to perform a transmission method for receiving frames from one transmission path, storing the frames in a plurality of buffers, and transmitting the frames to another transmission path, the transmission method comprising:
determining an estimated discard time of the frames stored in the plural buffers;
determining a transmission order of the frames;
calculating an estimated transmission time of each of the frames based on the transmission order; and
discarding a target frame from the frames stored in the plural buffers based on the estimated transmission time and the estimated discard time in a case where the estimated discard time of the target frame is the same as or earlier than the estimated transmission time of the target frame.
